(19) United States
(12) Patent Application Publication
(10) Pub. No.: US 2014/0317155 A1
(43) Pub. Date: Oct. 23, 2014

(54) RESEARCH DATA COLLECTOR AND ORGANIZER

(71) Applicant: SEARCHISTICS LLC, FOSTER CITY, CA (US)

(72) Inventors: VARDA TREIBACH-HECK, FOSTER CITY, CA (US); IAN D. HART, FOSTER CITY, CA (US)

(73) Assignee: SEARCHISTICS LLC, FOSTER CITY, CA (US)

(21) Appl. No.: 14/279,167

(22) Filed: May 15, 2014

Related U.S. Application Data
(63) Continuation-in-part of application No. 13/831,838, filed on Mar. 15, 2013.

(51) Int. Cl. G06F 17/30; G06F 3/0484

(52) U.S. Cl. CPC G06F 17/30091; G06F 3/0484; G06F 17/30861
USPC 707/811; 715/771

(57) ABSTRACT

A data source, such as a web page, a locally retrieved document, user-entered information, etc., is made visible to a user via a display, such as a computer monitor or touch-screen tablet or smart phone screen. A data capture window, which may be in the form of a data grid, is also displayed to the user, who can select data items from the data source such that they are represented in the data grid. Some data items may also be identified and collected automatically. Data collected into the capture window is then associated with corresponding portions of records in a data base.

### CROSS-REFERENCE TO RELATED APPLICATIONS

This application is a Continuation-in-Part of U.S. patent application Ser. No. 13/831,838, filed 15 Mar. 2013.

### FIELD OF THE INVENTION

This invention relates to a method and system for the collecting and organizing of data from web sites, web, phone and tablet applications or other installed and/or client-server and/or internet-based software programs, which allows for easy searching and retrieval, as well as collection and organization of observed and/or unobserved data.

### BACKGROUND

Significant research is done on the internet, either through open web-addressable content, web, mobile and client-side applications, through subscriptions or in other ways. Computers, phones, tablets, PDAs (personal digital assistants) and other electronic devices are of course commonly used to do this research. Research often involves multiple sources and when the screen size allows, multiple screens. Research is done for work and pleasure, for personal use and out of necessity. Some examples of the innumerable types of research conducted every day include shopping for a product, medical research, finding people, comparing candidates (such as when hiring), patent research, comparing dentists or physicians, problem-solving, knowledge seeking, literature searching, etc. Because of the vast amount of information available on the internet, virtually all research is now done wholly or partially online.

Often when doing research of almost any kind, the researcher wants to keep track of what was seen, where value was found, where there may be a resource for later use, where time was wasted, etc. For example, if a researcher is researching mobile phones with the intent of purchasing one, she may want to compare screen size, weight, features, appearance, accessories, phone service availability, etc. Some of these sites may, moreover, be useful to revisit when the researcher decides to buy a tablet computer and wants to make sure all the electronics work harmoniously together.

Another example would be doing online research about different physicians. For example, perhaps one has just moved to a new city and needs to choose a new primary doctor or specialist. One would want to compare factors such as years of experience, location, schools attended, specialties, insurance accepted, perhaps languages spoken, reviews and complaints (such as on Yelp, or through the American Medical Association or Better Business Bureau, for example), perhaps the physicians' interests, even the physicians' appearance if the researcher wanted a provider of the same sex or a younger practitioner for new approaches or an older practitioner for years of experience. The researcher may come across names or fields of practice that are not needed at the moment, but may be needed in the future. Bookmarking a page is ineffective and inconvenient if the page content changes.

What is needed is a single window data capture mechanism that does not slow down the user but memorializes the search process and grabs the data as it is indicated to have value. Currently, it is not possible to capture this information and organize it in a way that is easy to use, sort, filter, store and share. One might select, cut, and paste information from a web site into a Word document or Excel document, but this is tedious and time-consuming and requires a split screen and/or switching back and forth between applications. If the data captured were organized into columns, the number of columns or number of features being researched becomes a hindrance and significant time-taker. Copying images and HTML into client-side software also may cause formatting and functionality problems. Using existing software and methods, the search process is often disorganized, and there is often no way of managing multiple people doing research on the same topic. For example, if there were four Human Resource professionals all looking for suitable candidates for the same job, who all posted their curricula vitae on different websites, there is currently no good way of managing this process, including organizing the resulting data, keeping track of the discards and making sure the researchers are not looking at the same candidates and duplicating each others' efforts.

Currently, if an online researcher wants to create a report of her findings, she needs to create that report herself from scratch, using a word processing or other document. This requires a lot of custom formatting and may not even be possible if the report needs to include images, documents, or large blocks of text (such as source code, or long links etc).

Some web sites allow the user to click a “compare” box and compare several products, such as cell phones. This is helpful, but data compared may or may not be the data that the user wants to compare. Also, there is usually a limit of four or five items that can be compared at one time. A solution is needed which allows a user to research information in multiple web sites or applications and easily manage, save, organize and retrieve the data collected.

### BRIEF DESCRIPTION OF THE DRAWINGS

FIGS. 1-7 show sample researcher screens in an “overlay-based” embodiment.

FIGS. 8-17 show sample customer/designer screens in the overlay-based embodiment.

FIG. 18 illustrates a system that implements various embodiments of the invention.

FIGS. 19-28 illustrate a container-based embodiment of the RDCO system.

### DETAILED DESCRIPTION

Merely for the sake of succinctness, the system that implements the various common and optional aspects of different embodiments of this invention is referred to as the “Research Data Collector and Organizer (RDCO)” system. As is described in greater detail below, the RDCO system here solves the problems associated with researching several different, and unrelated, web sites and/or software applications. The RDCO system allows a researcher to layer an interface on top of any web site or software application, which allows the user to easily collect information, store the information in the RDCO system, and review and organize the information in a flexible report for later use. If desired, the data can also be mapped, formatted and exported into other software systems.

Two main types of embodiments are described below: An “overlay-based” embodiment, and a “container-based” embodiment. To understand the embodiments, and the differences between them, it is helpful to keep in mind what “overlay” and “container” are understood by skilled programmers to mean in this context.

Overlaying, that is, “Overlay_(programming)”, is described in Wikipedia (24 Apr. 2014) as “replacement of a block of stored instructions or data with another” and explains that “[c]onstructing an overlay program involves manually dividing a program into self-contained object code blocks called overlays laid out in a tree structure. Sibling segments, those at the same depth level, share the same memory, called overlay region or destination region. An overlay manager, either part of the operating system or part of the overlay program, loads the required overlay from external memory into its destination region when it is needed. Often linkers provide support for overlays.”

A container, that is, a “Container_(abstract data type)”, is described in Wikipedia (24 Apr. 2014) thus: “In computer science, a container is a class, a data structure, or an abstract data type (ADT) whose instances are collections of other objects. In other words, they are used for storing objects in an organized way following specific access rules. The size of the container depends on the number of the objects (elements) it contains. . . . Containers are divided in the Standard Template Library into associative containers and standard sequence containers. Besides [these] two types, so-called container adaptors exist. Data structures that are implemented by containers include arrays, lists, maps, queues, sets, stacks, tables, trees, and vectors.” As is also known, Java applets, frames and windows are commonly used examples of containers.

In this context, a “window” is a visual area that contains some kind of user interface; it is usually rectangular, can overlap other windows, and displays the output of and may allow input to one or more processes. Although the operating system (OS) will typically select the initial display size and placement of a given window, modern OSes allow users, for example, by “dragging” edges and corners, to resize the window, by dragging some other input field (such as a top banner area) to move it on the display, to maximize/minimize it, to select how it is displayed relative to other windows (for example, to be placed on top of them), etc.

The RDCO system may be configured to collect and store all data types. In this description, unless it is explicitly stated otherwise or obvious from context, “data” that the RDCO system can capture may be any body of digital information, including, but not limited to, data items such as formatted or unformatted text, SMS, chats, emails, faxes, screenshots, images, source code, file names, videos, documents, form field inputs, URLs or other network location indicators, time accessing the site, time on the site, user, whether or not the data is collected, in short: any data item that is information in digital form that is presented to a user in such a way that the user can select it for storage. The data may be collected in an easy, and sometimes even automatic, manner. For example, the URL, user, time accessing a site, source code, screenshot, etc. can be collected without the researcher doing anything since this information is available to software from the browser and operating system. Other data items may be collected easily, using known selection techniques such as copy-and-paste, drag-and-drop, a simple button, indicative HTML elements and manual entry.

The RDCO system may overlay a single web site or application that it is accessing for searching or collecting data items or multiple screens or sources so that it forms a single frame on the screen. The overlay may optionally be associated with a particular template chosen as being suited for the current search criteria. Common templates may be pre-configured and made available, or could be customized or created from scratch. The overlay may be opaque, transparent or semi-transparent, and either fixed or minimize-able. The RDCO system may be a parent frame, where the researched web site or application is a child frame. Ideally, for convenience, the RDCO system and the web site or application being researched are on the same screen and visible at the same time, making data collection much easier, especially on small-screen devices such as tablets and phones.

The RDCO system may have several functional levels and several user types with different roles. For example, the RDCO system may manage pre-existing templates, customized templates and projects. User types may include a designer role, a researcher role and a report reader role. Other roles may exist, such as customer, and these roles may overlap or totally coincide.

As used here, “templates” are configured sets of data collection fields configured either by the RDCO system or by a customer or administrator/designer. A custom template is a customized set of data collection fields that are set up by the designer. The designer may create a customized template from a pre-existing template, or may create a customized template from scratch. A customized template can also serve as a starting point, or a template, for future templates. A project is a set of one or more templates. The “designer” is the user type who sets up the customized templates and, possibly, a project. The “researcher” is the user type who collects data by interacting with the data portion of the template. The report “reader” is the user type who ultimately uses the data collected within a template, or project. Of course, these do not need to be separate people.

Privileges are generally set by the designer at the template level. Privileges may be set at other levels as well. Data is collected by the researcher at the template level. The data may then be stored in a database for storage, retrieval and reporting. The database is preferably unstructured, or open, so that it can store different data types easily. However, the database can be any common or commercially available database. The database can be separated from the user-layer software or can be fully integrated.

The data can be exported and/or encoded, for example, using Extensible Markup Language (XML), XML-based formats or other open standards markup language or schema systems or, in general, any computer language, for the representation of arbitrary data structures over the Internet so that the data can be used in a form, a web service or a configuration file for processing, or used in any other suitable way, after entry into a database.

By using the RDCO system, the researcher is able to quickly and easily collect useful data from a variety of disparate and separate sources so that the data can be used, for example, to further business objectives or help make personal or other decisions. For example, if a person wants to research different cell phone options, she can open the RDCO system and then indicate what template she wants to use and then visit the sites/applications she wants to research. For example, she may want to go to various web sites of cell phone manufacturers and service providers. She may be interested in specific features, such as cost, service provider, dimensions, appearance, camera resolution, weight, screen size, battery life, etc. To do this using the RDCO system, the user would navigate to these various sites within the RDCO system, and find the pertinent info for the various cell phone models. The RDCO system then allows her to easily enter (by copying-and-pasting, dragging-and-dropping or other known manual entry or selection methods) this info into the RDCO system, and ultimately into, the RDCO system database. The database may then include all the information for each of the phone models in which the user is interested. The database may also include the Uniform Resource Locators, or URLs, from which the user collected data and, optionally, the URLs from which she did not collect data. In other words, the RDCO system may, if this option is selected, keep track of everywhere the user visits, as well as whether the visit was productive or not, whether data was captured or not, etc. This feature, if implemented, would inform the user to avoid revisiting sites where she did not find useful information.

The resulting data can then be either exported or displayed to the user in any meaningful way. For example, the user may want to see the information presented in a spreadsheet or chart form which she can search, sort, and otherwise manipulate the data to her liking. The user may also want to export the data into another application for further analysis. The user may also want to allow another person to view the report, either on the web, on their phone, via email or by other means.

The various aspects—common and/or optional—of the RDCO system are described below in greater detail with reference to an example of an embodiment that is shown in the figures.

The RDCO system may have several functional levels and several user types with different roles, as mentioned above. For example, the designer may perform the traditional functions of an administrator, and may also set up a new data collection project and assign users access to it as well as choose, customize and identify access privileges for the project. The designer preferably also defines what data is to be collected and assigns any rules to the data collection process, such as which data is required and which is optional. The designer may also create the report format(s), possibly by selecting fields from a list, dragging and dropping collection field buttons into columns and determining filter criteria for the reports. There may also be a customer, a researcher, and a report reader, as well as other possible user types, as described above.

As used here, the “customer” will generally be the user who directs and oversees the project. The customer can also be the designer, but preferably with the power to remove a designer from a project once it has been created. For example, a customer/designer might be a recruiter who has several subordinate recruiters. She may then want data collected on different candidates for an open position. She, as a customer/designer, may then set up a new data collection project and assign users access to it. She can define what data she wants collected and assign any rules to the data collection process, such as which data are required and which are optional. The customer also has access to, and control of, the data as it is being collected. For example the customer may be able to view reports of the data as it is being collected, as well as who is collecting the data and how quickly. The customer/designer can also add researchers and report readers and define their privileges.

Alternatively, the customer role and designer role may be separate: The customer may direct the designer to set up the project in a certain way and simply review the results. In this case, the designer would be responsible for setting up customized templates and projects as well as, depending on the situation, for setting up privileges.

The researcher is the user who collects the data. There may be any number of researchers on a project, including only one. The researcher may or may not have access privileges to add new data fields whose entered data is to be collected. For example, if the researcher has these privileges, and notices that several of the recruiting candidates she is researching for an open position have interesting hobbies, she may add a data field to the project, on the fly, by simply creating a label, “Hobbies”. If this happens, the customer may be alerted and may be required to approve the addition. The researcher may or may not have access privileges as a report reader to the project reports or be able to edit data that has previously been collected and is present in the reports

The report reader is the user who ultimately reviews the results of the research project. In many instances, the report reader may be the same user as the customer. However, the customer may want to give report-reading privileges to others, including researchers, or other individuals. In the example of a recruiter evaluating candidates, the project customer may want to give report-reading privileges to the client doing the hiring. The customer may also give the report reader access to only a portion of the data. In this case, the customer would customize the reports and control who accesses which reports.

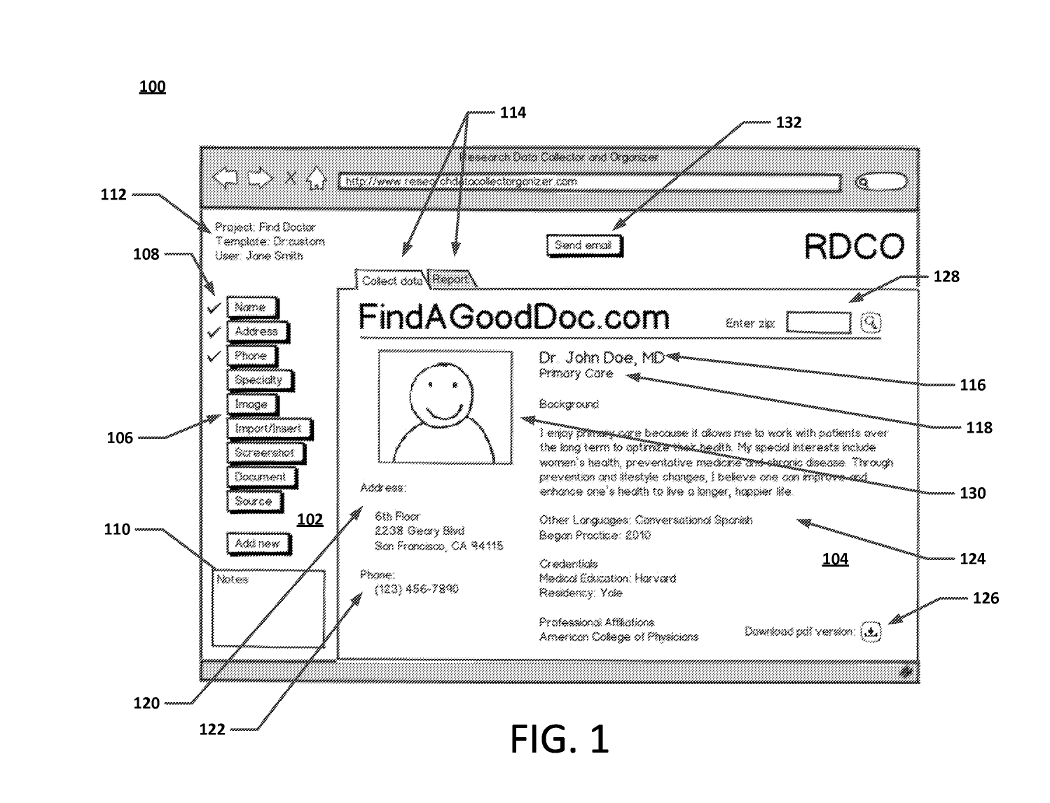

FIG. 1 shows screen 100 of one possible embodiment of the RDCO system and represents what a research user type might see after logging in and choosing a research project and template (if she is assigned to more than one) and going to a website for research. Keep in mind that the lay-out and data and information fields of the example illustrated in the figures are purely by way of example—designers of different research projects will of course typically prefer different templates. User and Template and Project info 112 is shown at the top left. In this illustration, the research project is called “Find Doctor” and the custom template is “Dr. custom”, the user's name is “Jane Smith”. There are two primary screen areas, or frame areas shown: 102 and 104. Screen area 102 is controlled by the RDCO system and may be made scrollable to be as long as necessary to house the data fields (scroll not shown, but well known to application designers). Screen area 104 is controlled by the site or application from which the researcher is collecting data. In other words, screen area 104 may in most cases be the window that the user's selected browser displays for the web page the user has navigated to or otherwise found. Screen area 104 may, moreover, be a web site in a frame (such as for the example web site FindAGoodDoc.com) within frame 102, which may in turn be a web site (illustrated as www.researchdatacollectorganizer.com) used to implement the RDCO system itself, or within a displayed frame created by a client-based application that implements the RDCO system locally for later data export.

In this sample screen, the web site being researched is called FindAGoodDoc.com. In this example, the researcher is collecting information relating to different doctors. There is information on the FindAGoodDoc.com web site includes such typical fields as doctor Name 116, Specialty 118, Image 130, general information 124, Address 120, Phone number 122, downloadable Document 126 and a form field 128 in which the user can enter data manually, in this case, a proximity preference indicator such as a Zip code. A Send email button 132 is illustrated to indicate an option to allow the user to send an email from the screen. For example, the user may want to send thoughts about important data collected from a particular web site immediately to the customer for the project. It would optionally also be possible to implement an auto-attach feature for the email, for example, such that a current URL is automatically embedded in body of the email, with a screenshot included as an attachment; an “Attach” label, icon or similar device could, for example, be included to indicate the corresponding data items, which may include the URL and currently active screen or screen portion.

Different elements on the RDCO system screen area may be made visible or not visible depending on how the template was set up by its designer. For example, here, buttons 106 and form field 110 represent some of the data fields the customer/designer has specified as important for the project: Name, Address, Phone, Specialty, Image, Import/Insert, Screenshot, Document, Source, and Notes. Other data for “hidden” fields (such as system time and the current URL FindAGoodDoc.com, etc.) may be collected automatically, and, as a result, may not need to be displayed and are therefore not visible in this example. Some of these fields may be required by the project, and some may be optional. Whether the field is required may be indicated by color or other graphical indicators.

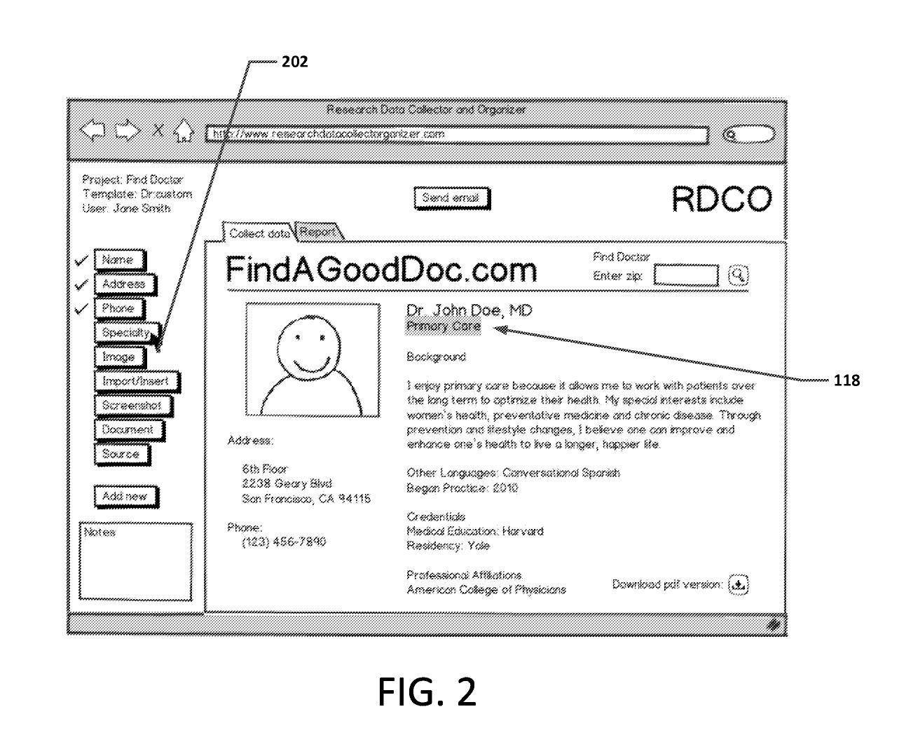

FIG. 2 shows the same researcher screen as FIG. 1 where the specialty “Primary Care” has been highlighted or indicated or otherwise selected. Highlighting a word or area can be done in any known manner, such as by using a selecting device to slide the cursor over the word while holding down a button, single clicking, double clicking, left or right clicking, hovering over the area, using a finger or stylus, mouse, or other selecting devices. A highlighted word, phrase or area may or may not show shading as shown in FIG. 2. For example, a single click may show only a cursor, some other indicator, or nothing at all. Selection of features in a displayed screen is a well-known operation and any preferred method(s) may be specified and implemented. Here, for convenience, all such methods and areas are simply referred to as “selection” or “selecting” and as being “selected”.

Once an area has been selected, the user may want to enter the information into the RDCO system. In FIG. 2 this is done by identifying the selected area 118, and then using the mouse or other pointer to click the appropriate entering mechanism or button or selecting device 202, which in this case is labeled “Specialty”. In doing so, the text “Primary Care” will be entered into the RDCO system in the “Specialty” field, indicated and controlled by input feature 202, which may be any desired graphical or text-input tool such as a button, a link, a text box, select list, etc.

Associating selected data with any of the data labels/input and collection fields 106 may be accomplished in any of many different ways. For example, assume the user has selected “Primary Care” and wants to associate it with “Specialty”, such that “Primary Care” is entered into the database as the specialty for Dr. John Doe, MD. One way would be to select the text and then to click on the “Specialty” button, as mentioned above. Another way would be to select the data item (“Primary Care”) and then “drag” this to the “Specialty” button.

It would also be possible to display a temporary drop-down menu after “Primary Care” is selected, with selectable options corresponding to the data label buttons 106; the user could then select which field to associate the selected data with. One disadvantage of this method is that it may obscure too much of the screen during the process; moreover, it would in many cases be redundant given the “active” buttons 106. Nonetheless, such alternative association methods may be useful in some implementations and fall within the scope of what a skilled system designer might consider.

An example of one such implementation in which it may be preferred not to have a fixed, visible display of the RDCO frame 102, or at least the template “label”/collection area/button 106, along with the frame(s) showing the data source(s) would be in the cases where the user is using a device such as a smart phone or tablet, with limited viewing area. Displaying all the information for both areas 102 and 104 might in such a case make it difficult to view everything at once, requiring frequent zooming, scrolling and sliding of the total display. If, after or before data item selection, the various entry fields 106 are instead presented to the user in the form of a drop-down menu, pop-up tool, or similar temporary graphical input tool, more of the limited display screen could be devoted to the active data source frame 104, thereby allowing the RDCO utility to remain wholly or partially “invisible” to the user while still having full functionality. Of course, this variation could also be implemented even on large displays. It would also be possible, using normal techniques, to allow the user to “toggle” between the RDCO frame 102 and the current data source frame 104, which would make it easier for the user to see, for example, the data presence indicators 108 or click or other RDCO control icons.

The system could also work in reverse, such that the user first selects the data label from the RDCO system, and then selects the research area that is to be associated with it. For example, the user could click on the data label/button (for example) 202 to select “Specialty” and then select the data item “Primary Care” in area 118. In either case, the corresponding data may be entered into the database at this point or reside in a buffer to be entered into the database later.

Local buffering of collected data may also be used to enable an “offline” or “real-time-updating” embodiment. In this embodiment, the RDCO system, which may be configured as a standard application or as an agent, sends buffered data to the project database when triggered to do so. One form of trigger event is that the user has completed the association of a data item with a data label; another could be that the user selects an RDCO control such as “commit” or “upload” or “finished” icon (displayed, for example, anywhere desired in the frame 102), or simply when the user exits the RDCO system. Another form of uploading trigger could be any edit to the data associated with the fields 106; this would implement a form of “synch-ing” with the remote database, as is found in some other commonly used applications. Still other triggers could be unrelated to user action. For example, triggering events could be such system-level events as the beginning or ending of continued execution of the RDCO execution thread according to the OS scheduler, the need to swap memory contents to or from disk, etc. Another trigger example could be time lapse or a time interval, according to some predetermined schedule, such as at the end of a day or hour, or more frequently if the amount of buffered data exceeds some threshold.

In one embodiment, the RDCO system may auto-format data for more logical data entry. For example, a user may select a full name, such as “Dr. John Doe, MD”. When the user enters this information into the RDCO system, by clicking a button or otherwise, the RDCO system may automatically break the text down into the following fields: Prefix, First Name, Middle Name, Last Name, Suffix, etc. Skilled programmers will know how to implement such “intelligent” data extraction/organization such that the RDCO system will know which part of the selected or indicated text goes into which field: “Dr.” would go into the Prefix field, “John” in First Name field, “ ” in the Middle Name field, “Doe” in the Last Name field, and “MD” in the Suffix field. The same could be done for other commonly entered fields such as dates, phone numbers, addresses, etc. Of course, manual resolution of the different names and separate selection and entry into the appropriate element in the entry field 106 may also be implemented.

In one embodiment the RDCO system may intelligently select data for data entry. For example if a user clicks on the screen between the “o” and “h” of “John”, the RDCO system may “look” at the information near the click and determine that the text clicked is part of a name. The RDCO system may automatically select the entire name, or auto-format the name text as described above. Other examples of intelligent selection include clicking on part of an image to select the entire image, double clicking anywhere on the page to collect a screenshot etc. Essentially any indication with the selecting device can be intelligently programmed to create certain actions in certain environments. This behavior can be set by preferences in the customized template or automatically performed and can be implemented using known techniques by skilled programmers.

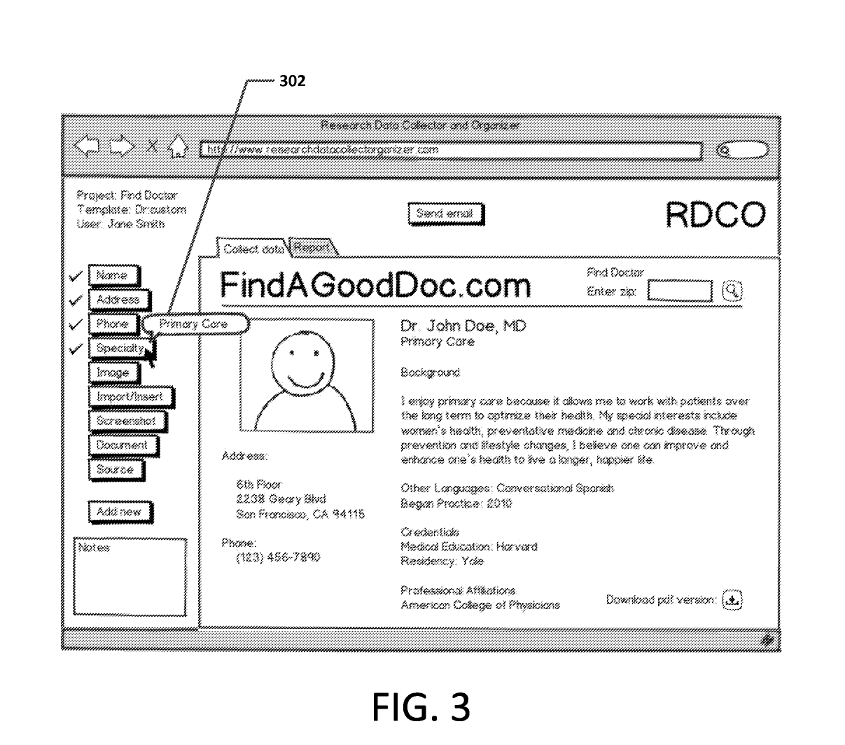

Refer now to FIG. 3. After the user has finished entering data with selecting device 202, a corresponding data presence indicator, check mark 108 may be displayed to indicate that the user has added data to the Specialty field. The user may then review the data item, for example, by hovering the selecting device over, or clicking, button 202 and viewing the entered data item in such display tools as a balloon or popup window 302. The user might also be given the option to deselect the check mark 108, for example, by double or right clicking, to undo and later re-do the entered data item. This may be because the user finds the entry to be incorrect, or simply wishes some other entry. For example, if Dr. Doe has more than one specialty, the user may wish to choose to store a different one instead of the one first selected. Data can be re-entered by repeating these steps and the new data can be viewed in the same manner that the originally entered data was viewed. As one option (not shown), the RDCO system frame 102 could include a button such as “Commit” or “Confirm” to indicate that she accepts the data that has been entered into the various fields and wishes to move on to a different frame 104. Depending on how the database is implemented, this could also signal that the captured data is to be moved from a local buffer to actual inclusion in the database. If the user is so privileged, she may also be allowed to view the data on the Report tab.

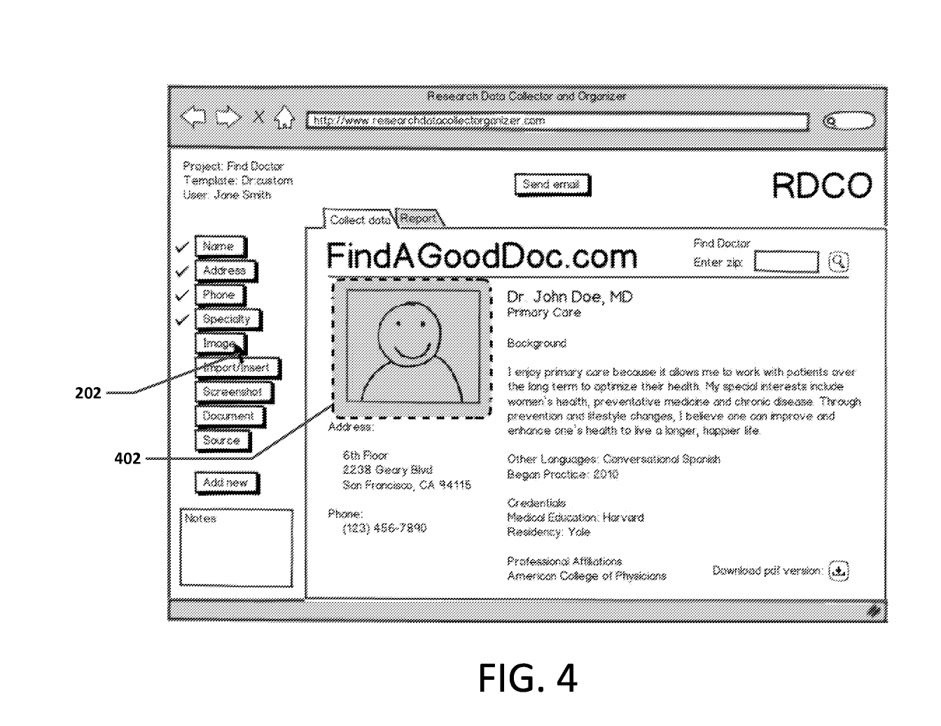

FIG. 4 shows an example of entering an image data item into the RDCO system. In this example, the user has selected area 402, which includes an image. The user can then click the data label button 202, labeled “Image” to enter the image data into the RDCO system, or use any other option for association of the data with the entry field, such as dragging-and-dropping, etc. The image may be entered in an appropriate format including TIF, JPEG, GIF, PNG, Bitmap, etc. Clicking on part of an image can be formatted to select the entire image.

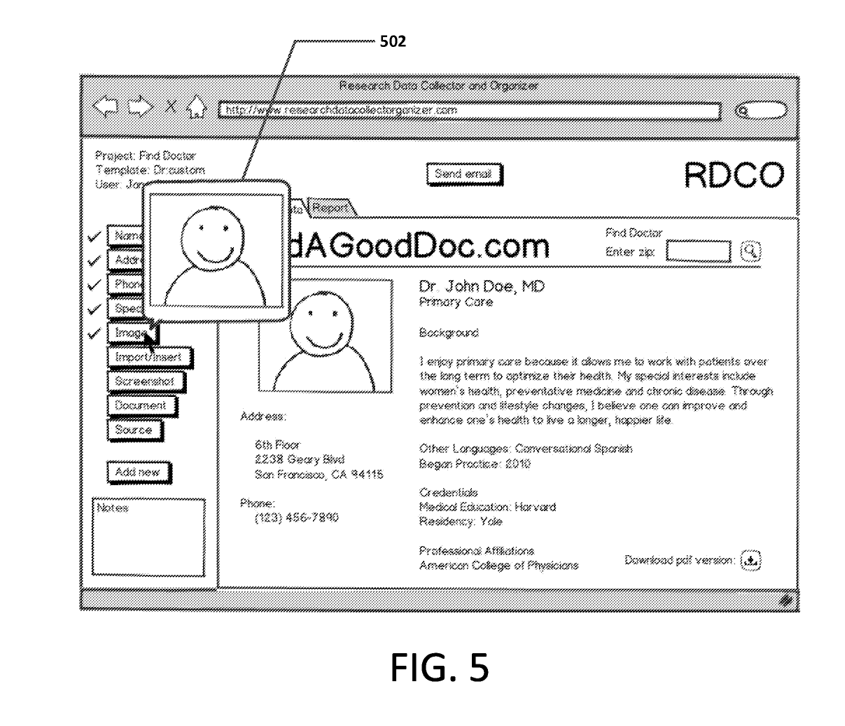

FIG. 5 shows how image data can also be reviewed in the same way text data can be reviewed, as in pop-up window 502. If the user is so privileged, they can also view the data on the Report tab.

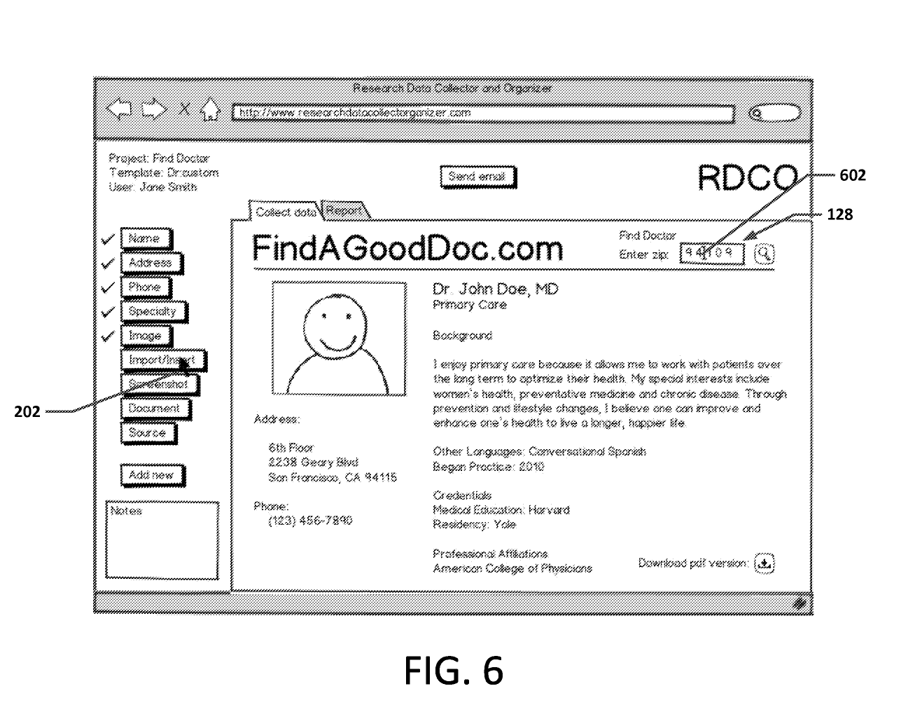

FIG. 6 shows how a researcher can collect information, not native to the web page or application but relevant to the research—user-entered information. In this example, the user has selected text, in this case Zip code information, in form field 128. Cursor 602 shows that the form field has been selected. After selecting the form field, the user uses selecting device 202 to select the “Import/Insert” button. When the “Import/Insert” button is selected, the researcher may then be asked to create a label or find a file, and, data from inside form field 128 is then entered into the RDCO system with the appropriate label associated with a corresponding database field, which may be created in any known manner.

Although a simple text box field 128 is shown here, other form field data can be entered into the RDCO system in a similar manner. In some form field types, such as checkbox, radio button, pull-down menu or other similar type of form field, the user may be able to click near the form field, or outline the form field using the selecting device. Alternatively, the user may select the entry mechanism, in this example the “Add new” button first, which could then trigger a list or menu of the various form fields in the page for the user to select. Additionally, the user may want to store the data from more than one form field and this option is also made available. Possible form field types might include text, password, hidden fields, text area, date, etc., or the current state of such graphical tools as a check box, radio button, drop-down menu, etc. Form field data could also be created at a “Create new template” phase so that the researcher indicates for the report reader other custom conditions.

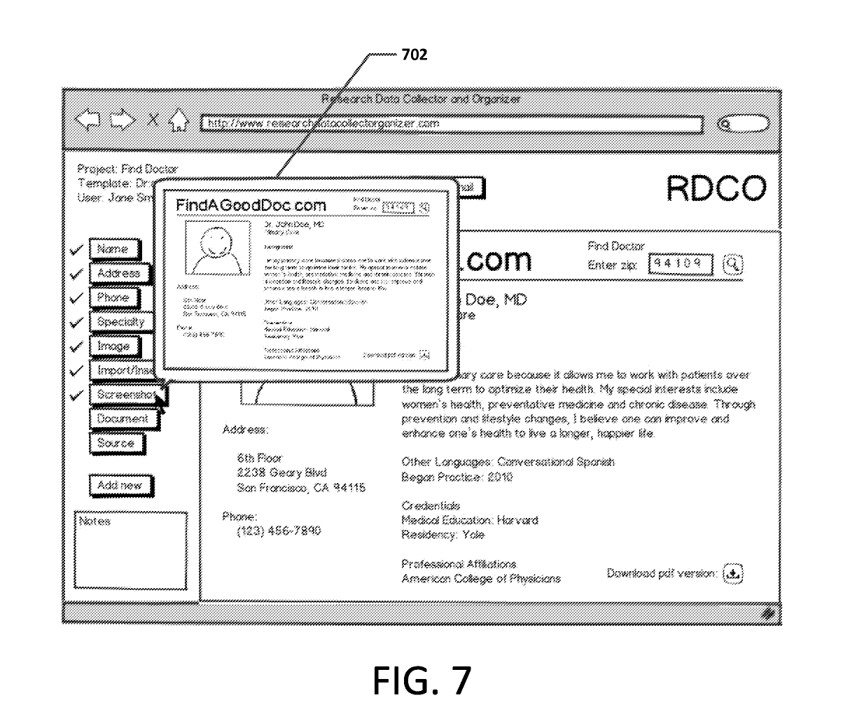

FIG. 7 shows an example of collecting a screenshot. A “Print Screen” function may be collected automatically in the background, or by a user indicating which portion of the screen to copy, using, for example, a “Screenshot” button as shown in FIG. 7. In this example, a screenshot is taken when the user clicks the selecting device 202, “Screenshot”, after which a representation of the screenshot collected is shown in pop-up window 702 when the user hovers over, or clicks, the “Screenshot” button. If the user is so privileged, she can also view the data on the Report tab.

Many programs such as Microsoft Word include utilities that enable selection and importation of external data into a current document. For example, one can import an image file into a text document or copy-and-paste text from one document into another by copying it to the system “Clipboard” and then pasting it from there into the desired document. A similar feature may be included in the RDCO system to enable importation into a database field from a source other than the immediately active web screen, such as from a different screen open in the same browser, a different document opened in a different program, or even an external file. The data can then be given an appropriate label as mentioned above, whereupon a corresponding icon/button could be added to the screen area 106. The underlying database may then have a new field added using known methods and the current template could be adjusted. Such alteration of the template would however, preferably require a proper privilege level for the current user. In this case, the user could, for example, select the “Import/Insert” button in the area 106, which could then either automatically accept whatever is currently in the Clipboard as its entry (similar to a common “Paste” feature) or it could then activate and display a window through which the user specifies a file (such as an image file) to be associated with the field. To ensure localized completeness of the database, the actual file data itself is preferably entered and associated with the field, but it would also be possible for a link or file name to be the entry as long as this will reliably lead to the desired data.

Importation of external information into the database entry of a current, but different, source might lead to lack of associativity of database entries with the current web page. In many cases, this will be acceptable—such externally retrieved data could be simply treated as one of the “Notes”, with no special label or need to alter the data structure of the underlying database. It would also be possible, however, always to store the identifier of the source (such as the file name, URL, etc.) along with any such imported data.

Data insertion from a Clipboard or the like need not be only from an external source. One other way for a user to select a portion of the displayed screen as data to be stored as an image would be to activate a utility such as the “Snipping Tool” included along with the Windows 7 and 8 operating systems or similar utilities provided along with other operating systems—using the tool, the user could select the desired portion of the screen area 104 (FIG. 1) and then “paste” it into the button of the area 106. In essence, “snipping” would therefore simply be another form of “selection”, creating an image.

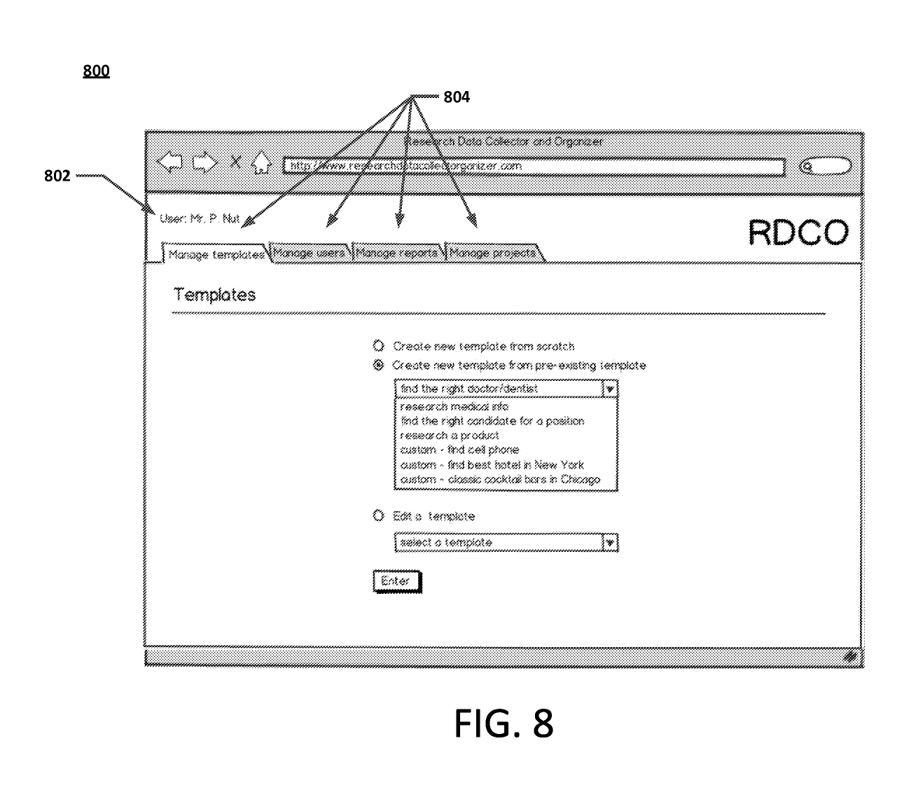

Consider now sample screens for the designer or customer/designer user type. FIG. 8 shows screen 800 of one possible embodiment of the RDCO system. This screen represents what a customer/designer user type might see after logging in to the RDCO system. User name 802 is shown in the upper left and tabs 804 indicate, and allow the user to choose among, different areas of the customer/designer interface to the RDCO system. In this example these tabs represent the “Manage templates”, “Manage users”, “Manage reports” and “Manage projects” sections.

Screen 800 shows the user in the “Manage templates” section. The user has the option of creating a new template from scratch, from a pre-existing template or to edit a pre-existing template. Other template management tools may be presented here.

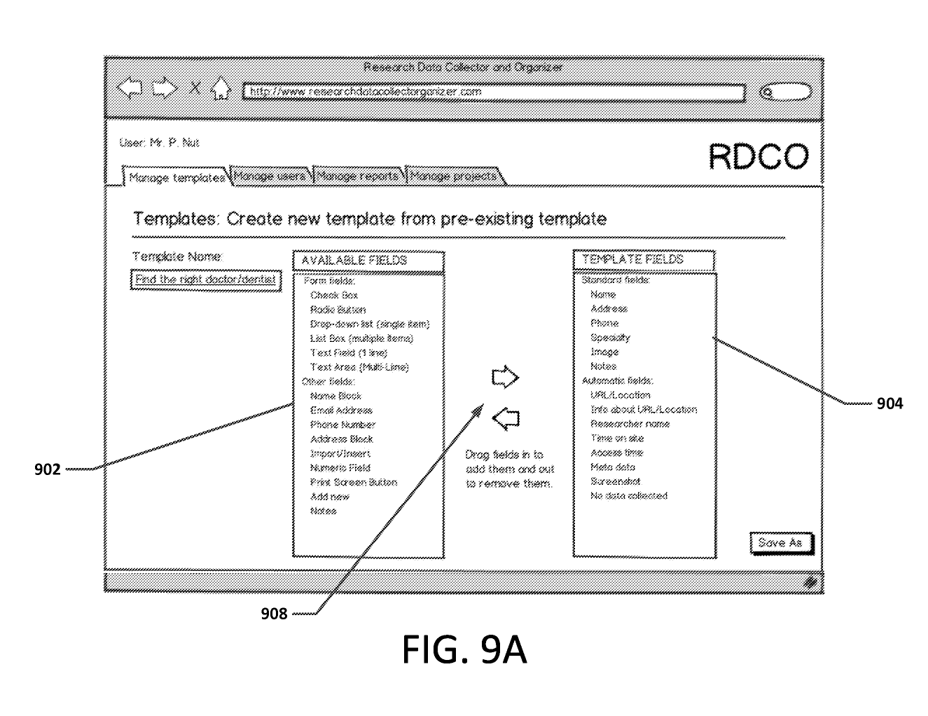

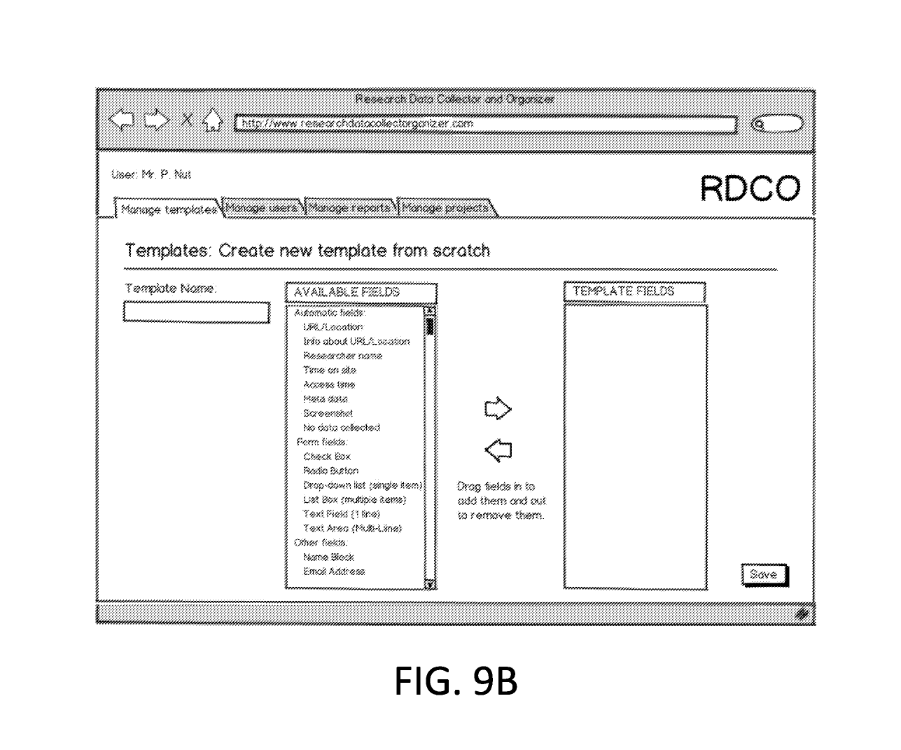

FIGS. 9A & 9B show example screens of how a customer/designer can create a new template from a pre-existing template or from scratch, or by editing an existing template. In the pre-existing example, the user has chosen the template “Find the right doctor/dentist”. AVAILABLE FIELDS window 902 lists some of the form field types available to the user. Other pre-configured field types are also listed here. TEMPLATE FIELDS window 904 shows the fields that have been chosen for the current template. Automatic fields within the window, shows some of the fields that are collected automatically by the RDCO system. The user may be able to drag and drop the fields from one window to another, or the user may use indicators 908 to move fields from one window to another. In this way, the user can fully customize the data collected for the project. The user may also choose to have more than one field of a certain type in the project. For example, the user may want to collect two different form fields such as a radio button and a list box.

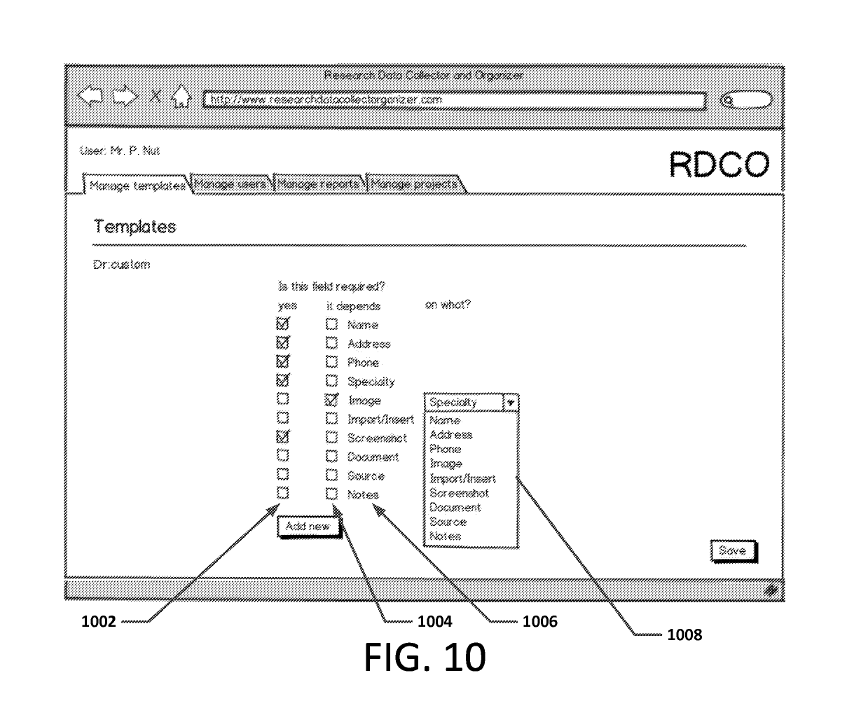

FIG. 10 shows an example of how a customized template can be configured on a more detailed level. This screen shows how the individual fields can be further defined, including whether they are required or optional, or if fields are dependent on another field. For example, the user may not want a field to show up unless a response is found or the response to another field is a particular response or one of a group of particular responses. Or, the user may not want to mark a particular field as required unless the response to another field is a particular response of one of a group of particular responses. On this screen, column 1002 shows whether a field in field list 1006 is required. Column 1004 allows the user to identify whether a field depends on another field. Pull-down menu 1008 lists the available fields used to define dependence as configured by the user (response criteria is not shown). The Add new button brings the user back to FIG. 9, should she discover she is missing a field while in FIG. 10.

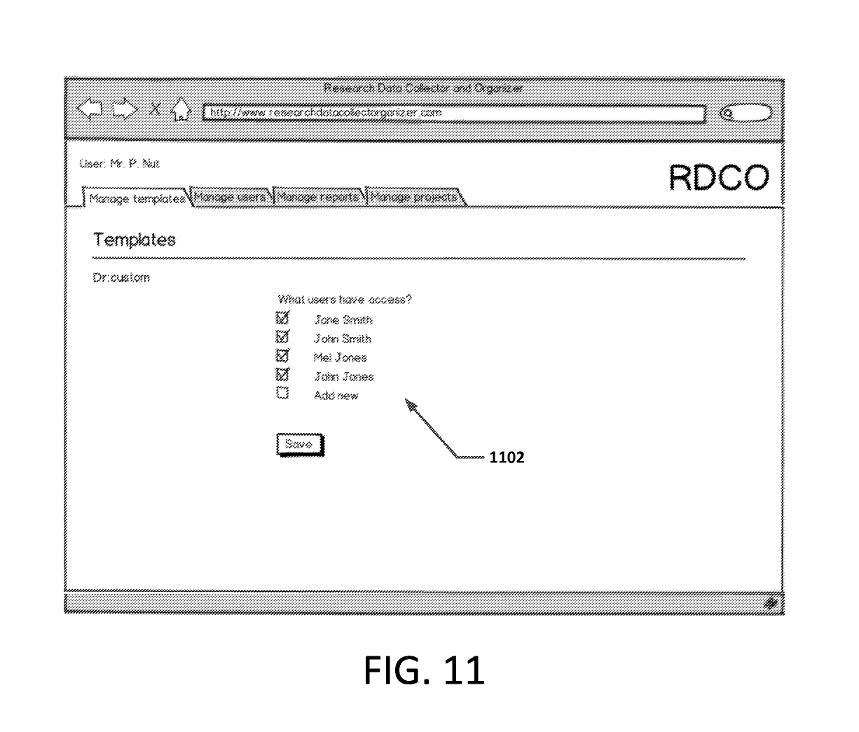

FIG. 11 shows an example screen of how the customer/designer of a template can give different users access to the template. The customer/designer is shown a list of possible users 1102, and can select which users have access, and/or create a new user.

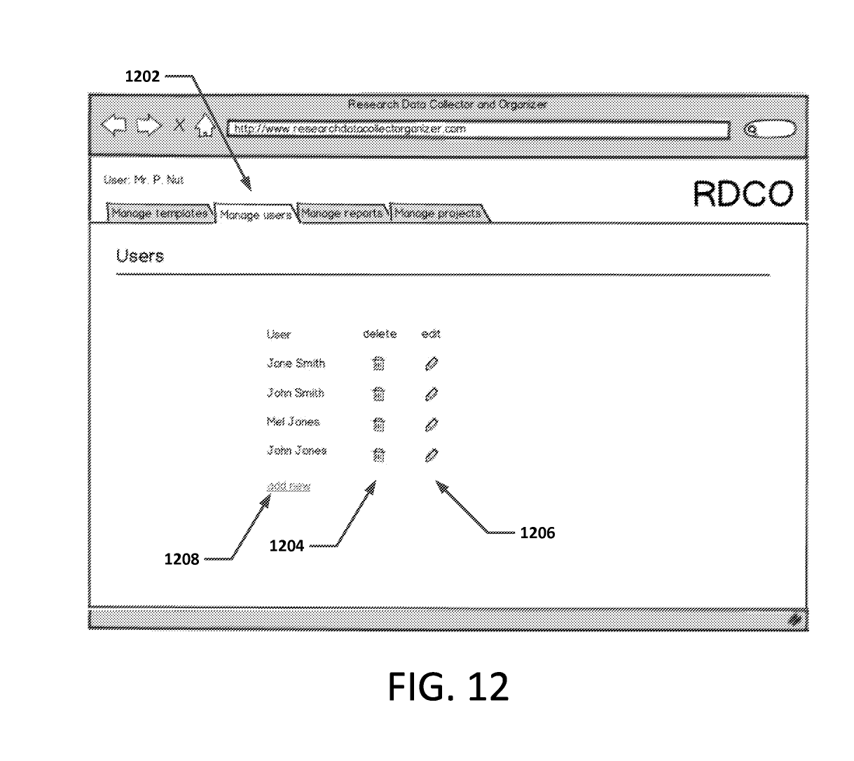

FIG. 12 shows an example screen of how a customer/designer can manage users under tab 1202. Here a customer/designer can edit, delete or add a new user using edit links 1206, delete links 1204, and add new user link 1208 respectively.

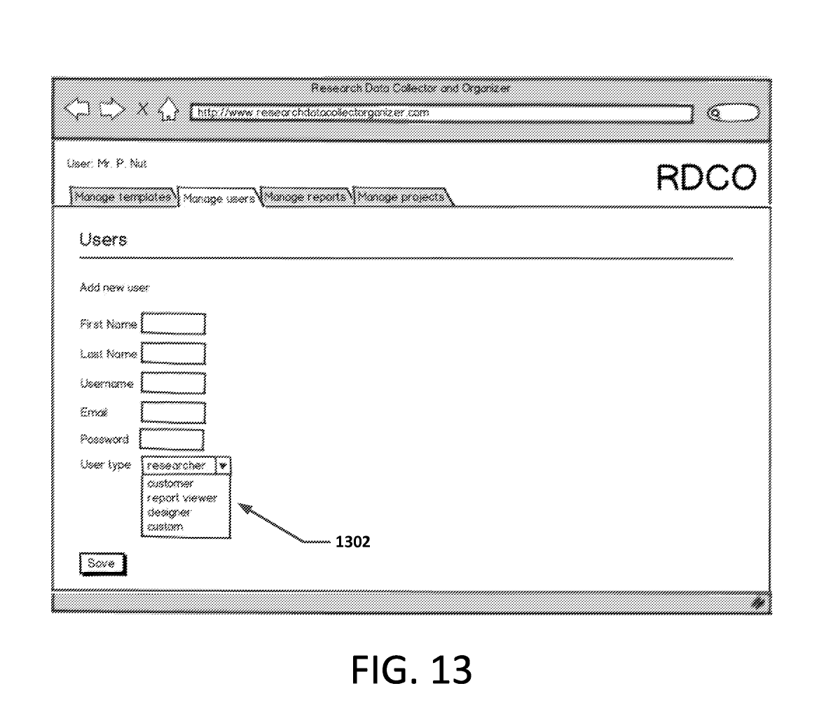

FIG. 13 shows an example screen of how a new user can be added. The customer/designer can further identify what kind of access and what privileges each user has. For example, some users may be given research access, to collect research data, while others may be given report access, to view the research report. Users may have more than one type of access and access may differ depending on templates or projects. User types can be assigned using pull-down menu 1302. User types can also be managed, and custom user privileges set, using other tools (not shown).

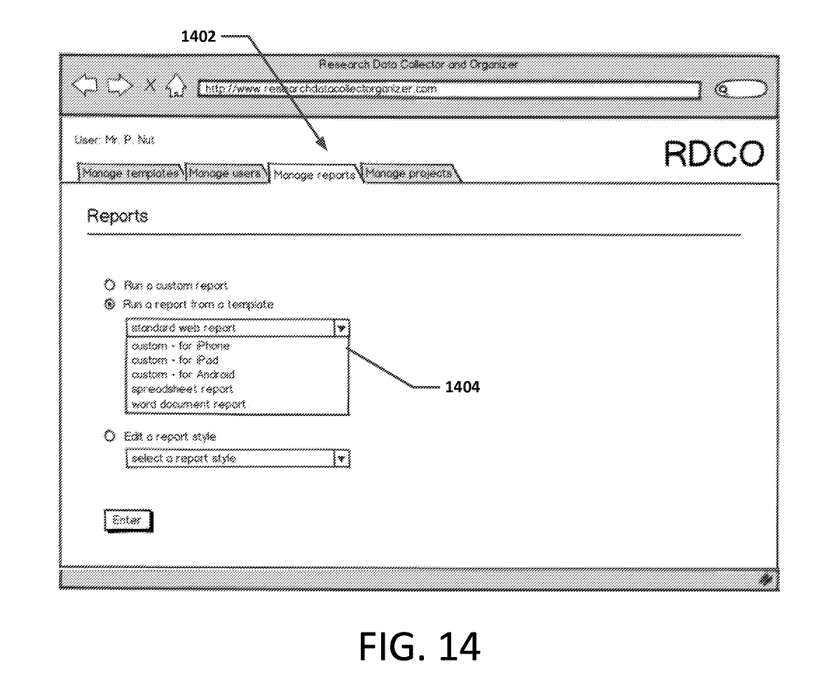

FIG. 14 shows an example screen of how a customer/designer can manage reports under tab 1402. Here a customer/designer can create a custom report, create a report from a template, or edit a report style. Pull-down menu 1404 shows an example of report types available from templates. Some of these reports may be provided with the RDCO system and some may be created by the user.

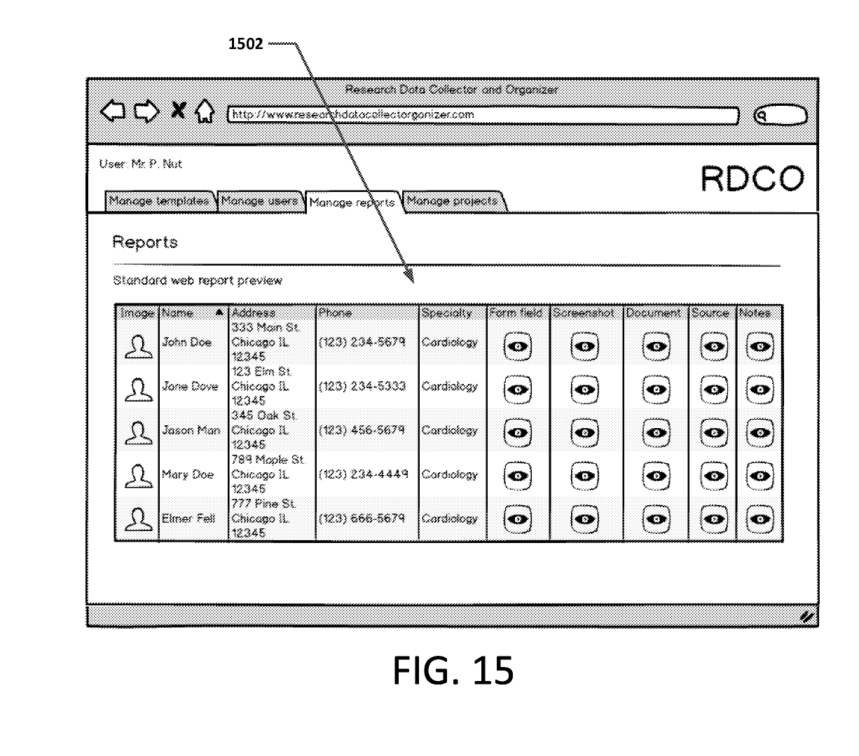

FIG. 15 shows an example report screen that a customer/designer is reviewing and a report reader might see. In this example, the data is presented in a spreadsheet, or chart, format. Spreadsheet 1502 shows the project data and can be configured in any way that a standard spreadsheet can be configured, including sorting, searching, hiding data etc. Depending on the data type, some of the fields may show the actual data, and some of the fields may provide a link to the data. Images and larger data may be represented by thumbnails with links to more detail, or larger images. If needed, a report editor could be available to reorganize data after it is reported.

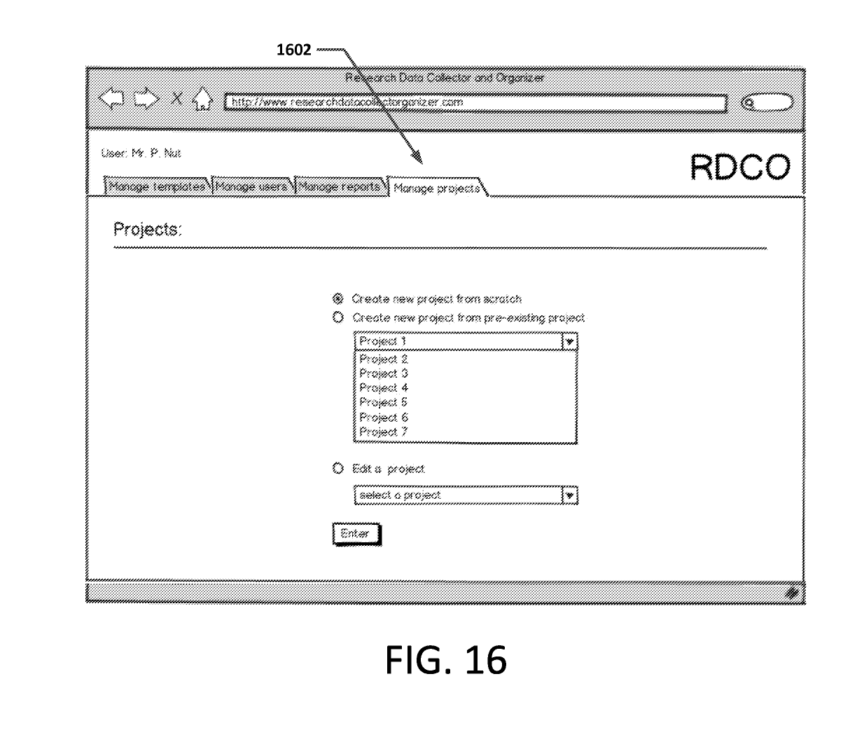

FIG. 16 shows an example screen of how a user can manage projects under tab 1602. Here a customer/designer can create a new project from scratch, create a new project from a pre-existing project or edit a project respectively.

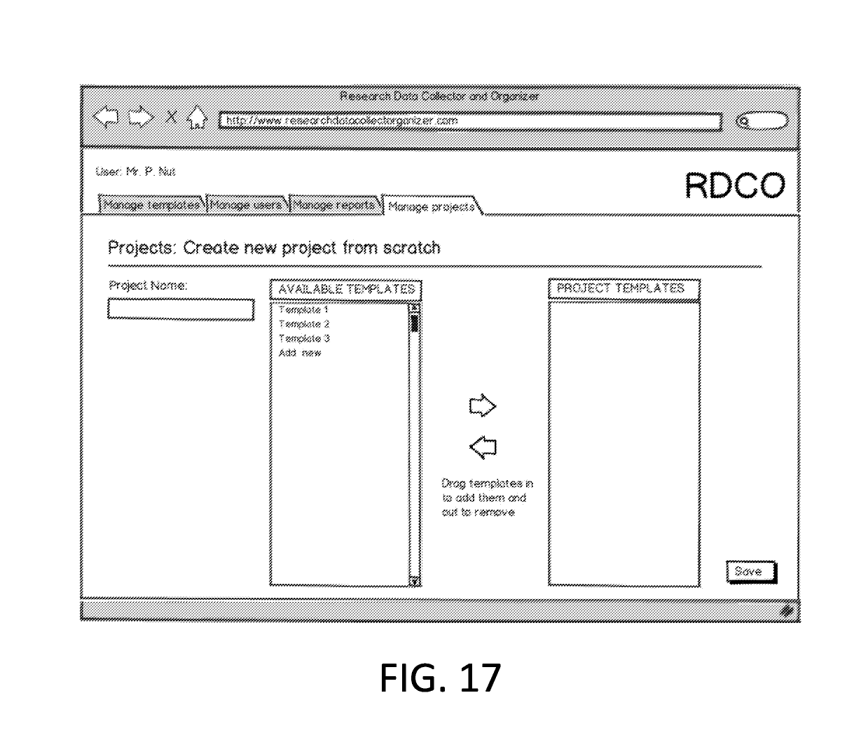

FIG. 17 shows an example screen of how a customer/designer can create a project from scratch. In the example, AVAILABLE TEMPLATES window lists the templates available to the user to be assigned to a new project. PROJECT TEMPLATES window shows the templates that have been chosen for the project.

Reports may also involve exporting data, including exporting for other applications, exporting in Comma-Delimited File Format, Field-Delimited File Format, Microsoft Excel File Formats, Tab-Delimited File Format, XML File Format and other formats.

Reports can be viewed on the internet, in an application, on a computer, tablet, phone, or any other appropriate device.

The RDCO system may operate over the internet and/or other network. The system may be client-server based or web-based or application-based. Devices which can access the system include computers, phones, tablets, personal digital assistants and any other device with the hardware and software necessary to view and/or use the RDCO system.

The computing device on which the RDCO system is implemented may include a central processing unit, memory, input devices (e.g., keyboard and pointing devices), output devices (e.g., display devices), and storage devices (e.g., disk drives). The memory and storage devices are computer-readable media that may contain instructions that implement the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

In the example embodiment illustrated in FIGS. 1-17, it is shown that the RDCO system is accessed online through entry of the proper URL such as www.researchdatacollectorganizer com and the site of interest is also an online source, illustrated as FindAGoodDoc.com. In other words, in the illustrated example, not only is the research being done in web sites, but the RDCO system is accessed and run through the internet, such as being an application in the “cloud” or at least remotely. This is only one possibility for implementing various aspects of the invention: In other implementations, either or both of these two “parts”—the active data collection source, illustrated in FIG. 1 as frame 104, and the RDCO data collection and organization system illustrated as frame 102, could be implemented either remotely or locally.

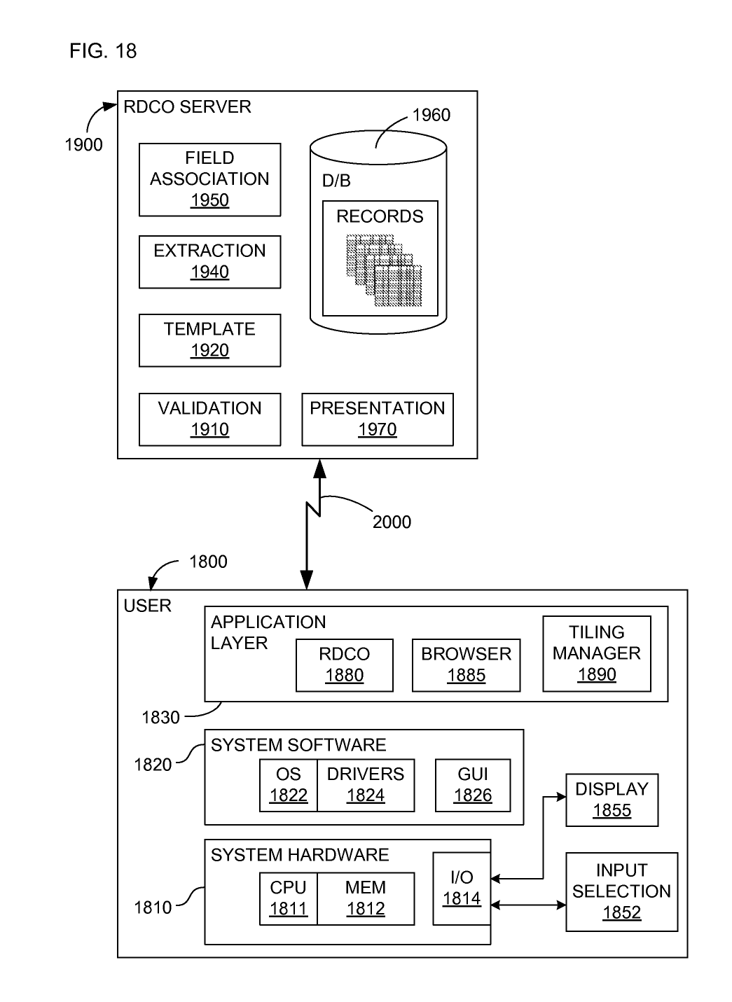

FIG. 18 illustrates a general system that can be used to implement various embodiments of the invention. FIG. 18 illustrates one user-level system 1800 that interacts with a RDCO server 1900 over a network 2000 (such as the internet, a telephone network, etc.), but this is merely for the sake of simplicity. The different user roles (such as designer, researcher, report reader, etc.) may have separate user-level systems, and in some implementations some of the user roles may coincide; indeed, in some implementations (such as the “local/local” embodiment), the user-level system 1800 and the RDCO server 1900 may be found within a single entity and even a single computer, with no need for an external network connection at all. For some roles, not all of the components of the user system 1800 as shown in FIG. 18 will be necessary, as one will understand from the description of the various user roles above, for example a report reader may not need an input/selection device.

At the user level, system hardware 1810 includes one or more processors (CPUs) 1811 and one or more volatile and non-volatile memory devices 1812, which may be used to implement the local data buffer if this design feature is chosen. The system hardware will typically also include I/O cards and controllers 1814 as needed to communicate with and control such input and selection devices or routines 1852 such as a mouse (or trackball, joystick, etc.), keyboard (or speech recognizer, etc.), touch-screen sensor, etc., as output devices such as a display device 1855, which may be a separate monitor, incorporated as, for example, a tablet or smart phone touch-screen display, etc.

System software 1820 will typically include some type of operating system (OS) 1822 and various drivers 1824 that are used for software control of physical devices; note that the drivers 1824 are typically installed in the OS itself. A graphical user interface (GUI) controller 1826 is also often an integral component of the OS.

An application/user software layer 1830, which typically runs at the user level, is usually installed to run on the system software 1820, although many applications, especially on virtualized platforms, nowadays are executed from a remote server in an arrangement often called “cloud computing”. There are of course countless applications and it is these programs whose operation is most visible to users. One application is a browser 1885, which, as is well known, is used to retrieve, interpret, display and interact with content accessed over the Internet.

An RDCO software module 1880 is included in the user-level system 1800. This module 1880, which may be programmed using known techniques given the description here of its novel functions, carries out the various tasks described above, such as transferring for display the selected template, interpreting user selections and commands (which she may enter using the input/selection mechanism 1852), sensing, accepting and formatting data that the user has selected and entered, and mapping, exporting, encoding or presenting schema systems for communicating with the RDCO server 1900, either via the network 2000 or internally if this component is included in the user system 1800. As mentioned above, the RDCO module may be implemented as a typical application, or as an agent.

The RDCO server 1900, or equivalent user-level components, includes a validation module 1910 to perform such tasks as identifying which user is connecting with the RDCO server and what privilege level the user has so as to prevent unauthorized accesses and edits. A template module 1920 stores the various templates, and interacts with the designer (who will be at some user level connected to the server 1900) to create new ones. A data extraction module 1940 evaluates records received from the RDCO component 1880, which in turn will have got them from users' (in particular, researchers) interaction with selected data source(s) and a current template. A field association module 1950 then ensures that the data in the various fields is in the proper format (if this isn't already done by the RCDO module 1880) and enters it into the appropriate field and or record of a database 1960 (embodied in some form of non-volatile storage device), corresponding to the current project. A presentation module 1970 is preferably included to retrieve requested database records and present them for viewing and analysis by the user, such as the report reader.

It is not necessary for there to be only a single database 1960; databases could be distributed based on size or project demands, or hosted in the “cloud” and distributed as part of the business model. It is also advantageous to store the research data in more than one database, for both security and redundancy functions. One instance where this might be desirable is when one's database is highly sensitive to hacking (such as a law firm's or government agency) and a copy would be made and periodically compared with the local server copy to ensure that data had not been tampered with. Essentially a copy—is hosted remotely, such as in “cloud storage”, not only for back-up, but also to ensure ongoing data integrity.

As is described in greater detail below, an alternative embodiment of the RDCO system also solves the problems associated with researching several different, and unrelated, web sites and/or software applications. The alternative embodiment of the RDCO system gives a researcher access to a container (which may be or include such graphical elements as a dedicated window, browsing tab, etc.) adjacent to any web site or software application, which allows the user to easily collect information, store the information in the RDCO system, and review, organize, edit, delete, label, copy, share and print the information. If desired, reports can be generated or the data can also be mapped, formatted and exported directly or indirectly into other software systems.

As with other embodiments, this embodiment of the RDCO system may be configured to collect and store all data types, including, but not limited to data items such as formatted or unformatted text, SMS, chats, emails, faxes, screenshots, images, source code, videos, documents, form field inputs, URL or location, time accessing the site, time on the site, user, whether or not data is collected. As with other embodiments, the data may be collected in an easy, and sometimes even automatic, manner. For example, the URL, user, time accessing a site, source code, screenshot, etc. can be collected without the researcher performing any additional steps since this information is available to the RDCO system from the browser and operating system. Other data items may be collected easily, using selection techniques such as copy-and-paste, select-and-paste, drag-and-drop. This data may be collected using click-able areas that include but are not limited to buttons, installed icons such as tools, bookmarks, bookmarklets, browser extensions, browser toolbars or toolbar elements, operating system toolbars or operating system trays, indicative HTML elements and manual entry.

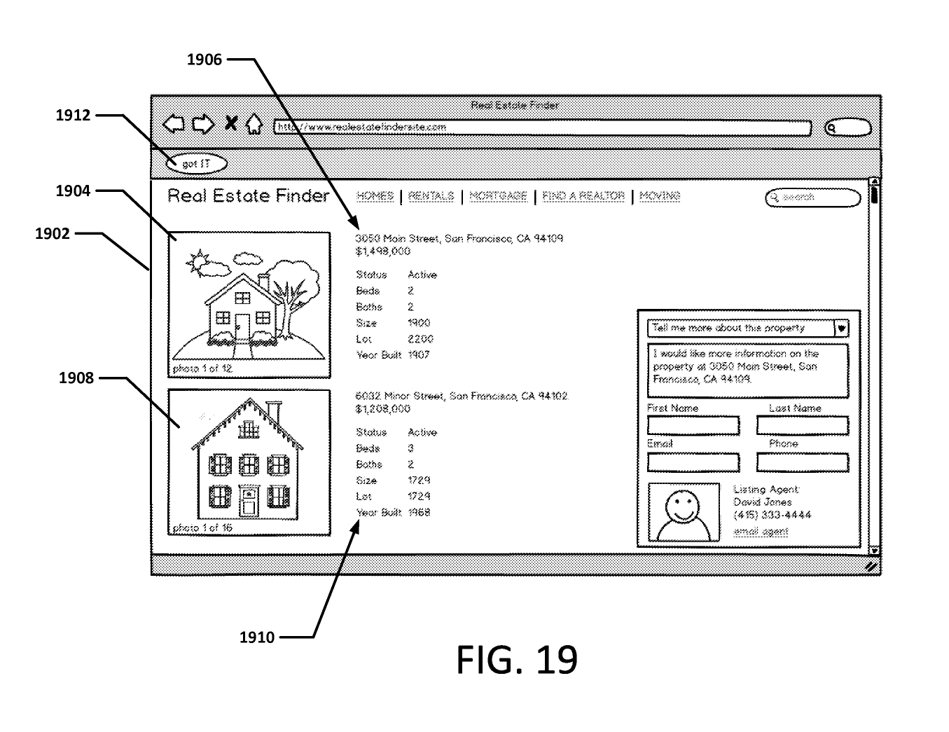

A web-based embodiment of the RDCO system is represented in FIGS. 19-28. FIG. 19 shows web browser window or tab 1902 containing a web site used for searching and researching real estate listings. For convenience, all the different possible variants of 1902 windows, tabs, etc.) are at times referred to below as the “primary window”, in that it is the window (or equivalent), that is, the delimited display area, of current interest for searching and possible data capture. This is just an example web site and could be any web site, including one that researches cars, other products, consumer goods, job candidates, apartment or vacation rentals, etc.

This example web site shows more than one property listing. These listings may be the result of a listing search. The first property listing is illustrated with image 1904 and text description 1906. A second property listing is illustrated with image 1908 and text description 1910. More listings may exist beyond the visible window; for example, there may be more property listings on this web site that match the search criteria that can be seen by using the scroll bar of the web browser. More information than is visible may be associated with each listing. For example, clicking on the image or text associated with each listing may bring the user to another page which shows details of the listing, more images associated with the listing, files associated with the listing etc.

Link 1912 is a bookmark or bookmarklet, or browser extension or browser tool or other click-able link or icon associated with a client-side or a server-side script, or a script file loaded from a URL or a shell to load resource files onto a standard markup language page (or any combination of these) to interact with any element found on a standard markup language web page. The script or script file comprises machine readable computer code that temporarily interacts through on-click events with a standard markup language web page or container and its images to trigger various kinds of useful functionality. Script or script files may contain link tags, style sheets, event handlers, dependent files or any other elements or attributes known to those skilled in the art. Script or script files may have the caching enabled or disabled and the code compressed or left as is. A bookmarklet may be installed by dragging it to the Bookmarks Bar and, unlike browser extensions, may not have any effect on installed files. Clicking link icon 1912 launches the RDCO system. When the on-click event is completed, the corresponding function is finished and the user clicks link 1912 again to enable RDCO functionality for another event. Because each browser-based on-click event is a discrete temporary event, more than one link icon like link icon 1912 may be presented on-screen at the same time to perform different types of on-click events; for instance, one may exist for images and one may exist for automatic data extraction. However, in some circumstances and when logically possible, rather than multiple link icons, a single on-click event triggered by a single link icon may be programmed to actually perform as if there had been multiple on-click events via multiple link icons.

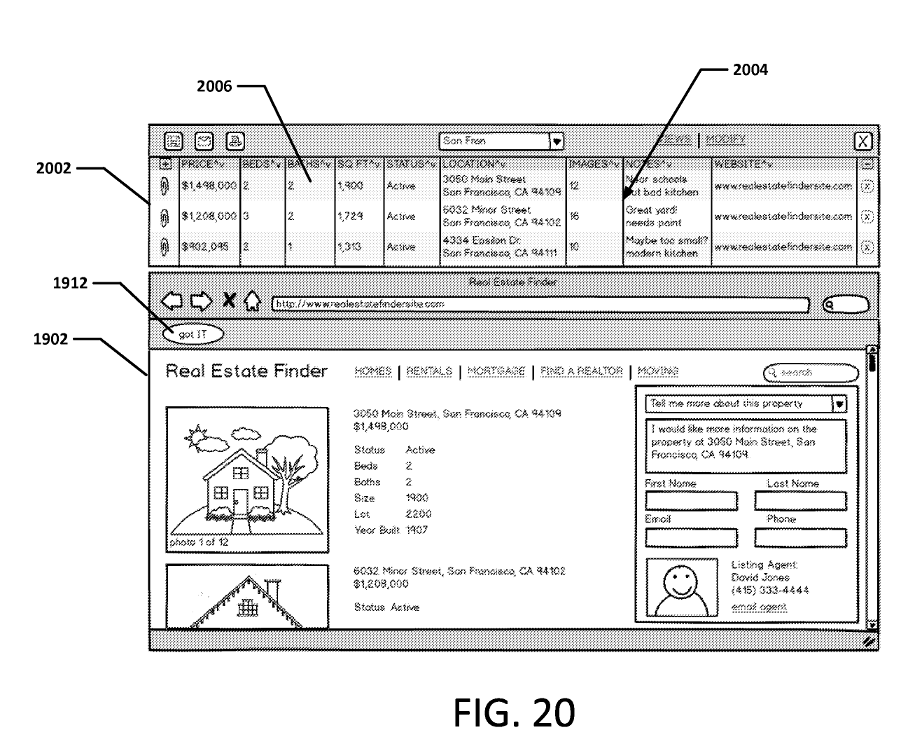

FIG. 20 shows a possible result of clicking link icon 1912 or otherwise initiating an RDCO data-capture session. In this figure, a second web browser window or tab 2002—for convenience, referred to below at times as the “data capture window”—has opened and is visible along with the original web site shown in the primary window 1902. In this example, the data capture window 2002 and/or the primary window 1902 have been automatically sized to fit on the same tab or user screen. In this example, the data capture window 2002 is the same width and is placed above the primary window 1902. The data capture window 2002 may instead be placed below or to the left or to the right of the primary window 1902. The primary window 1902 may also change dimension to allow for both windows to be viewable at the same time on the same monitor screen.

FIG. 20 illustrates some advantageous features of the container-based embodiment: For one thing, as the user manually (and/or the RDCO system automatically) selects data from the window 1902 and places it into the appropriate cell of the data grid 2004, the thus captured data is visible at a glance to the user rather than being “hidden” beneath (that is, associated with but not immediately visible) data label buttons 106. Another feature in the illustrated embodiment is that the windows 1902, 2002 are displayed as mutually non-overlapping frames. The RDCO system preferably accomplishes this by configuring a known tiling window manager.

Tiling window managers have been included in commodity operating systems for at least about 20 years, for example, in all versions of the Microsoft Windows line of OSes since Windows 95. As is well known, tiling windows managers provide an alternative to the more popular approach of coordinate-based stacking of overlapping objects (windows) that tries to fully emulate the desktop metaphor. In many cases, applications may not be able to access and control the operation of an OS-based tiling windows manager at all, or beyond some rudimentary operations such as selection of which windows the OS is to tile. Even in systems that allow such access and control, however, more sophisticated tiling functionality is now available using third-party, commercial tiling windows managers that are loaded as applications and interact with the underlying OS. Such an application-level tiling manager 1890 is shown in FIG. 18. One example of a commercially available tiling windows manager that may be used in conjunction with the RDCO system to suitably size and tile the windows 1902, 2002 to be non-overlapping and in a single on-screen view is marketed by Soulid Studio under the name “Mosaico”. Mosaico tiles windows using a “drag&go” feature or keyboard shortcuts and saves and can restore windows' positions and sizes in a snapshot. Other tiling windows manager software available at present includes the programs SplitView (tiles windows using caption buttons and keyboard shortcuts, optionally maximizing windows to a screen part); WindowSizer; WinSplit-Revolution (tiles windows using keyboard shortcuts); HashTWM (provides automatic tiling); GridMove (tiles and arranges windows on sophisticated layouts with hotkeys and multi-monitor support); MaxTo (tiles windows on user-defined grid by intercepting windows that are maximized or using hotkeys and also supports multi-monitor setups); etc.

Different monitor screen sizes will dictate how the two (or more) windows are automatically sized so that they are both visible.

Many modern users have two or more monitors connected and active at the same time, and modern operating systems such as Windows 7 and 8 allow a user to include and configure multiple displays, such that at least one is an “extended” display. It would therefore be possible for the RDCO system to display the different windows 1902 and 2002 on different monitors.

Image processing software such as SVG images and such software command-line utilities as ImageMagick may also be used to cause windows to be rendered in any desired popular image format. Scalable Vector Graphics (SVG) is an XML-based vector image format for two-dimensional graphics that has support for interactivity and animation. The SVG specification is an open standard developed by the World Wide Web Consortium (W3C) since 1999.

Although FIG. 20 shows the second web browser window 2002 open in a separate window from the original or “base” web browser window 1902, the second web browser window may also open in the same window as the original web browser window, possibly in a pop-up window or a frame of the original web browser window. The sizing of the frames/windows/tabs can be controlled by the RDCO system regardless of the format (frame, tab, pop-up window etc.) using known “window.open” methods for interacting with the chosen browser, however individual web sites or an individual's browser setting may interfere with this functionality unless a window tiling manager function is executed at the Operating System level

The web browser window 2002 may be arranged and displayed so as to contain a data grid 2004 that contains several data cells 2006. In this example, the data cells have been automatically populated with specific data from the current web site displayed in web browser window/tab 1902. As is well understood, a browser renders a web page for display in accordance with the HyperText Markup Language (or similar) code that defines the page. This code is accessible to applications outside the browser itself, such that the RDCO component 1880 (see FIG. 18) may extract data into the grid 2004 according to the corresponding HTML tags. In this case, the data may be automatically captured and displayed in the appropriate data cells. This data is preferably also recorded in the database 1960 of the RDCO system. Other data beyond what is visible in the data grid illustrated in FIG. 20 may also be recorded in the database of the RDCO system. This data may include, for example, the date/time of the recording, the user, the user's access time, the complete URL, screenshot(s), general text, downloadable files, hyperlinks and image files from the site, etc., In this case, the RDCO system may have had prior knowledge of the web site in web browser window/tab 1902 which allowed it to map the data from the various listings to the appropriate fields in the data grid. For example, the RDCO system may be configured for a specific user group, such as real-estate professionals, who may research web site listings that have a standardized format with data tags that allow for convenient analysis and data extraction. In this case, the web site in web browser 1902 is considered “automatically mapped”. Once the data is automatically captured and displayed in the data grid, the user can view image thumbnails and hover to view larger images, add unstructured notes into a text box in data grid 2004, edit image and file labels, sort the data, take partial screenshots, delete images and rows, scroll through listings, etc., in browser window 2002.

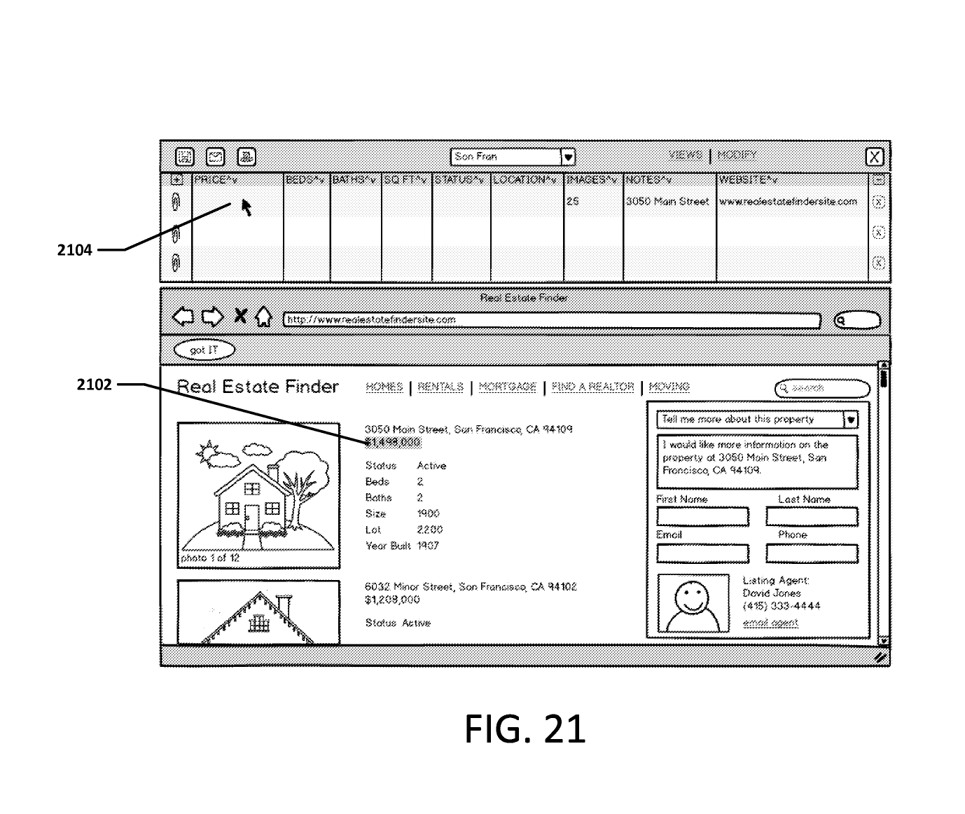

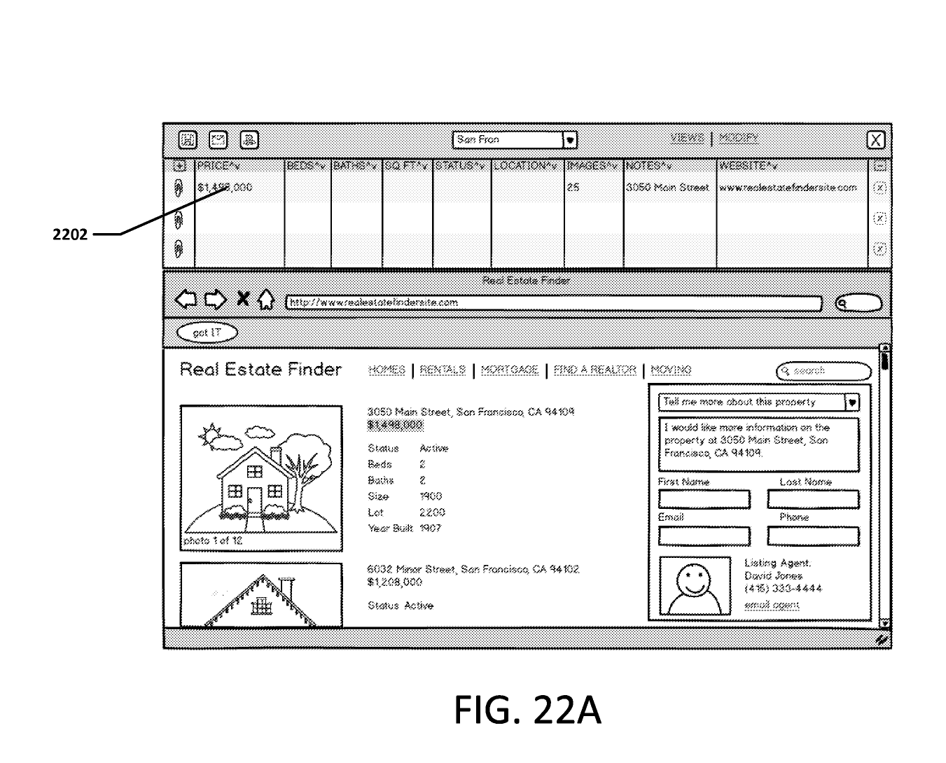

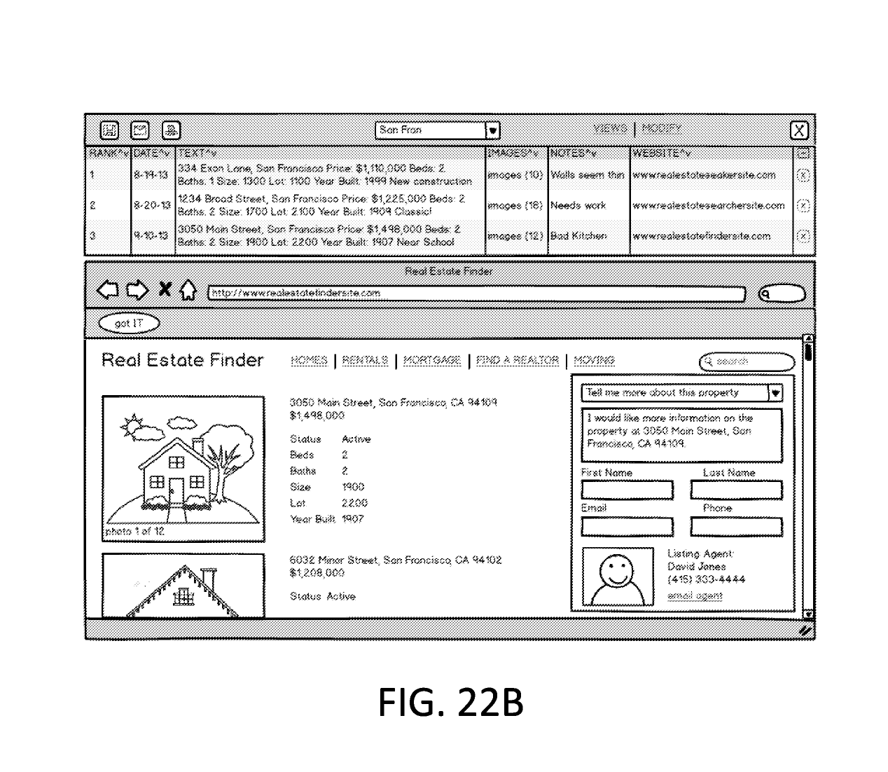

FIG. 21 shows an example of a type of data grid associated with a “manually mapped” web site. In this example, the RDCO system does not have prior knowledge of the location of the various fields within the web site shown in web browser window/tab 1902. The lack of prior knowledge may be because that website has never been identified as one to be mapped, or the web site in window/tab 1902 dynamically populates its data from the server, or the data or data location changes frequently in some way, or has an otherwise non-static or non-standardized format. The data grid associated with a “manually mapped” web site has fields, or column (or row) headings, which the user has manually created and placed into a template, in addition to possibly standard RDCO fields/column headings. For example, the user may make a template for real estate searches or product searches. In FIG. 21, these manually created fields include “BEDS”, “BATHS”, etc. The “WEBSITE” field may be an example of a standard RDCO field. In this example, the RDCO system records the web site address (URL) in the “WEBSITE” field, and optionally extracts and stores image items such as a screenshot, and, if available, other site images, and enters these in the “IMAGES” field of the data grid. The user can then manually add data from the web site into the data grid by typing or copying directly into content editable fields, and thus updating the database of the RDCO system. Some columnar data may be entered manually into the data grid, and the user can, as with the automatically mapped sites, add notes, image labels and files, sort the data, take partial screenshots, delete images and rows, scroll through listings etc. in browser window/tab 2002. In short, instead of associating on-screen data with data label buttons/collection fields 106, the user in this embodiment may associate on-screen data with cells in the data grid 2004, which the RDCO then enters into the database 1960. Other data beyond what is illustrated in the data grid in FIG. 21 may also be recorded in the RDCO database. Example of such data may include the date/time of the recording, the ID of the user, the complete URL, downloadable files, etc. Another type of data grid for “unmapped” data could be more general—for example, see FIG. 22B.

In the example of a “manually mapped” web site, users can also copy and paste text or images from website tab/window 1902 into the data grid and the database of the RDCO system by selecting or highlighting and clicking To do this, the user highlights or selects an area on the original web site, here shown as selection 2102 (FIG. 21). This is done with a pointer, such as a mouse, or finger or other pointer. The pointer is then used to click on an appropriate cell of the data grid, in this example, cell 2104. Once the cell is clicked, the data (such as the price $1,498,000) is entered into the data grid as shown by cell 2202 in FIG. 22A. The data may then also entered into the RDCO system database 1960.

FIG. 22B shows an example of the data grid associated with an “un-mapped” web site, that is, a web site whose data structure has not been associated with corresponding columns of the data grid. In this example, the RDCO system does not have a pre-made template to match the search criteria of the site and so presents a “general” or “default” template to the user. In the illustrated example, the RDCO system records the web site address in the “WEBSITE” field, takes a screenshot, and, if available, places images in the “IMAGES” field of the data grid. The type of data such as web address, file type (jpeg, for example), text data can be determined using know methods from the HTML code defining the current site. The user can then manually add data from the web site into the data grid, and the database, of the RDCO system. The user can, as with the mapped sites, add notes, image labels and files, sort the data, take partial screenshots, delete images and rows, scroll through listings, etc., in browser window 2002. Other data beyond what is illustrated in the data grid in FIG. 22B may also be recorded in the database of the RDCO system. This data may include the date/time of the recording, the user, the complete URL, downloadable files etc.

At any time, templates can be modified by the user to add new columns, delete columns, change column names, format columnar cells and run filtered reports. Also at any time, new custom templates can be made. The procedures for doing this differ from those used to edit templates in the embodiment described in conjunction with the description of FIGS. 1-17 in that the user may complete a list of categories they want to track and this list becomes column headings for a data grid.

The RDCO system provides a very easy way to enter data into the data grid and into the database of the RDCO system. This works because the data grid shown in web browser window 2002 appears and functions as a spreadsheet, but because it is in a web browser window/tab, HTML elements, scripting and application programming interfaces may be used to perform the spreadsheet type functions. For example, when the user clicks on a cell of the data grid, a scripting function such as the JavaScript “onclick” function is called, which allows the binding of arbitrary data to a Document Object Model (DOM) which pastes the selected data into the appropriate field and record of the RDCO system database and also displays the data in the cell of the data grid. Other spreadsheet functions can also be performed in this way, such as sorting, deleting and altering records. JavaScript, Perl, Python as well as other scripting languages can be used to perform these functions. These scripting languages support programs written for a special run-time environment that can interpret and automate the execution of tasks which could alternatively be executed one-by-one by a human operator. This could also be done with known methods of Operating System applications with a 3GL-type language like Delphi or C++ which allows the binding of arbitrary data to the Operating System Clipboard.

Note that information and data from one or more originating web sites can be inserted into one RDCO project. For example, a user can visit multiple different real estate web sites and incorporate the data from all of them into one project called “San Fran”. The data from the multiple originating web sites can then be entered into and presented in one data grid within the RDCO system. This could be accomplished by leaving the RDCO window 2002 active on-screen while opening a different web site in the base window 1902. From the perspective of the RDCO system, the main change would be in the URL, and this change of active URL could be a trigger that initiates extraction and capture of any “automatic” data, before switching to any manual data capture mode.

Data from multiple sites can also be presented on one row. In this embodiment, a “project” may or may not incorporate information from multiple web sites. Additionally, in this embodiment, a “project” may or may not include one or more templates.

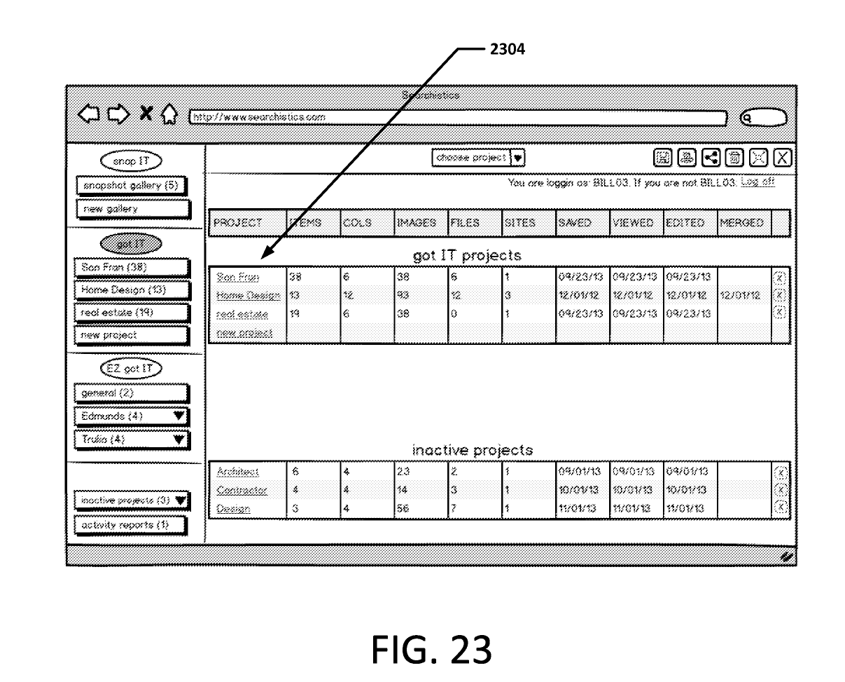

FIG. 23 shows an alternative way of viewing and managing the data and information in the RDCO system. FIG. 23 shows a web browser window/tab or application page that is displayed when a user of the RDCO system logs in directly or otherwise opens the RDCO system. In this example, the user is BILL03. On the left are several buttons or links that allow the user to view his/her data in different ways. In the illustrated example, the buttons presented to the user include three optional choices “snap IT”, “got IT”, “EZ got IT”, which indicated various features a user may choose such as “images only”, “for experts”, and for automatic capture, respectively, as well as individual project links and other links. The screen shown in FIG. 23 shows the “gotIT” button as highlighted, indicating that the user has clicked on, or otherwise selected, the gotIT link. The RDCO system displays a list of the user's projects 2304 within the got IT category. From here, the user can view and manage his/her projects. Different such optional features may be presented to users as choices in other implementations of the main ideas of the different embodiments.

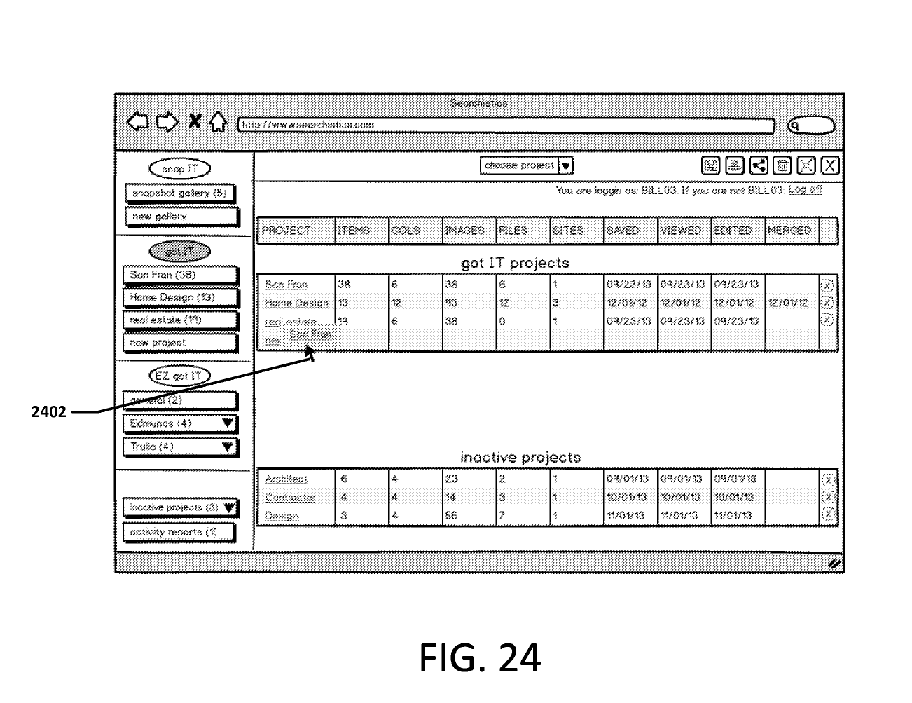

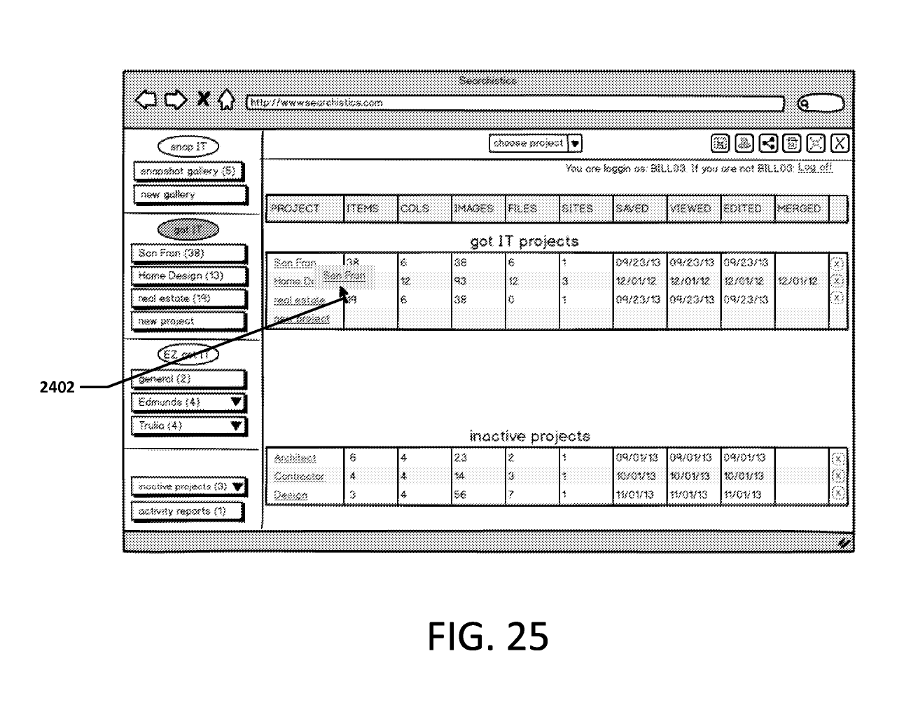

A user may create a new project by clicking on the “new project” button or, if the user wants to create a new project based on a previously created project, also called “cloning” a project, she may click and drag a project name and drag it over the new project link as shown in FIG. 24. In the example shown in FIG. 24, the user uses pointer 2402 to drag the project named “San Fran” onto the “new project” link to clone the “San Fran” project. The same can be done with the “San Fran” and “new project” buttons on the left side. This same drag-and-drop procedure may be used to merge projects as well. FIG. 25 shows how a project name can be clicked and dragged over a different project name to merge the two projects. In FIG. 25, project “San Fran” is shown being merged with project “Home Design”.

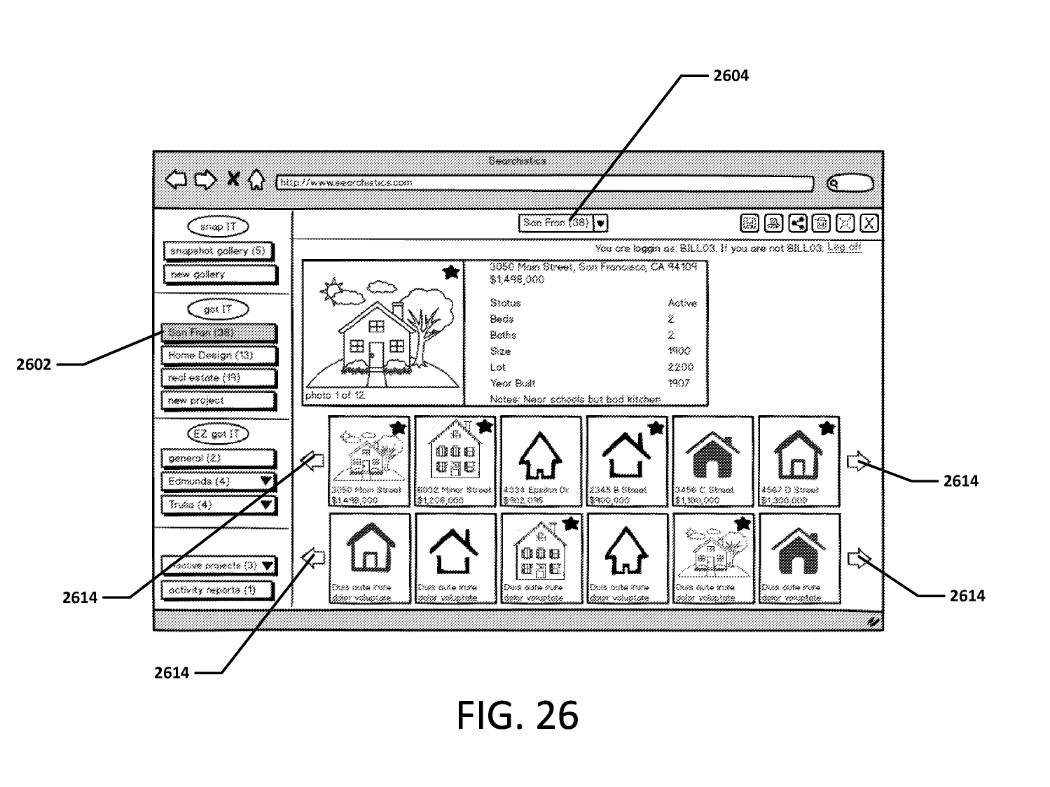

FIG. 26 shows a screen which may be displayed when the user selects “San Fran” button/link 2602 on the left or the project named “San Fran” has been selected as shown in pull-down menu 2604. This view allows the user to easily scroll through the data and images in a given project and mark some of them as favorites or finalists. In this example, the properties in the “San Fran” project are shown along with relevant details. Scroll arrows 2614 can be used to scroll through the selections.

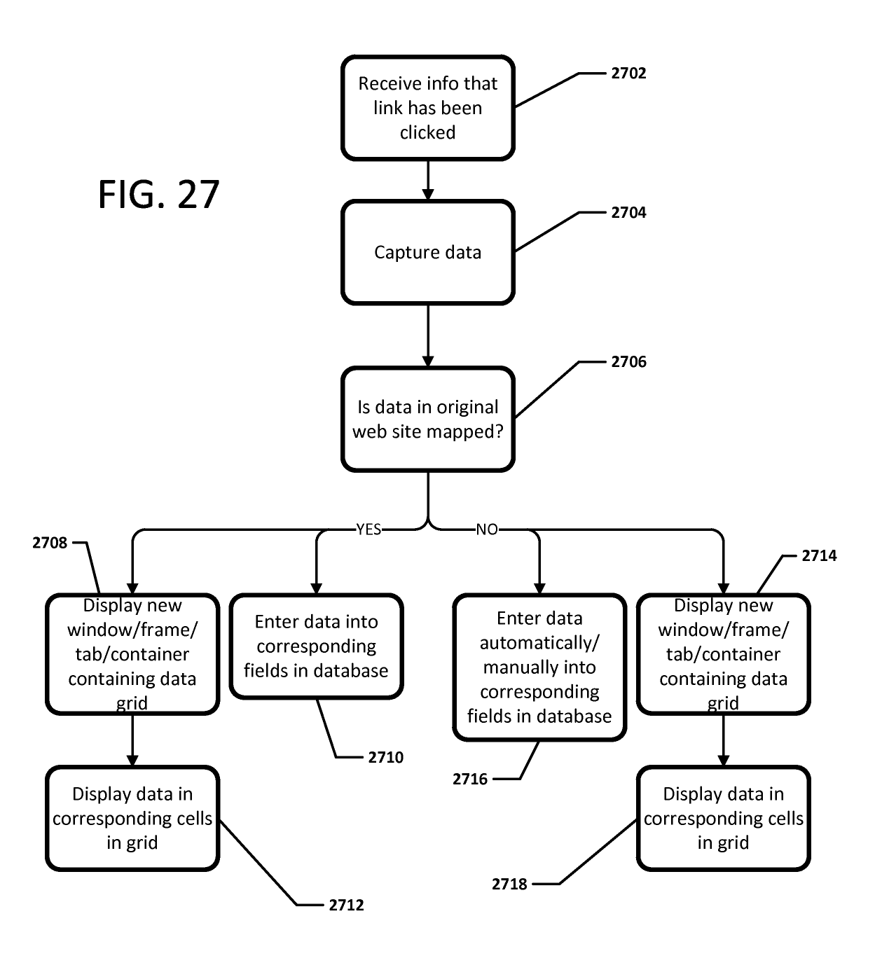

FIG. 27 shows how the user's clicking on, or otherwise selecting, link 1912 launches the “faux” spreadsheet or data grid 2004. Box 2702 represents the RDCO system receiving the signal that the user has clicked or otherwise selected link 1912.

In response to the click of the icon, the RDCO system captures data using techniques according to the rules (coded, for example, in a lookup table) relating to the link and whether the data is mapped or unmapped. The URLs of mapped websites may similarly be stored in a lookup table (which could also be the same table in which its respective rules are stored). For example, commonly used websites in a given field (such as real estate locators, the USPTO patent database, etc.) have substantially fixed formats, such that the type, category and absolute or relative location of different data may be knowable in advance and therefore amenable to description based on rules. Given a URL, the RDCO system can therefore determine whether or not the originating web site has been previously mapped. Box 2706 shows this decision point. Data may include images, text, files, links, URL, screenshots, current date/time, user, as well as everything previously discussed and everything available for capture. The capturing of the data is represented by box 2704.

If the originating web site has been previously mapped, the RDCO system enters the captured data into the RDCO database in whichever structured format that has been chosen. This means that the appropriate data is placed in the appropriate fields of the database. For example if the originating web site is a real estate web site, the RDCO system may automatically place the city name in the city field of the database, the zip code in the zip code field of the database, etc. This process is shown in box 2710.

The RDCO system may also display a dedicated container or window or frame containing the data grid. The window or frame is sized to fit in the user's window adjacent to the window of the originating web site. The originating web site window may also be resized so that both the data grid and it will fit in the user's window. This step is shown in box 2708.

If the originating web site has been previously mapped, the RDCO system may display the data from the original web site in the appropriate cells of the data grid. For example, if the originating web site is a mapped, real estate web site, the RDCO system will automatically place the city name in the city cell of the data grid, and the zip code in the zip code cell of the data grid. This process is shown in box 2712.

For manually mapped websites and websites not previously mapped, the RDCO system may automatically place the data it auto-captures in the database and then record the data entered by the user one cell at a time as described above in the descriptions of FIGS. 21 and 22A, B. This process is shown in box 2716. The RDCO system also may display a dedicated container or window/tab or frame containing a general or pre-configured or custom data grid. The container, window/tab or frame is sized to fit in the user's window adjacent to the window of the originating web site. The originating web site window may also be resized so that both the data grid and it will fit in the user's window. This step is shown in box 2714.

If the originating web site has not been previously mapped, the RDCO system will still display the data it has auto-captured from the original web site in the cells of the data grid. For example, the RDCO system may or may not automatically place all the text in the notes cell of the data grid, and all the images in the images cell of the data grid. This process is shown in box 2718.

Visiting a given URL may also be used to trigger other optional features. For example, if the RDCO senses that any of a set of pre-specified URLs has been visited, this itself could be used to automatically direct the system to open a corresponding data capture window. Or, if a user, visited a site and did not capture data at all it could log the url and date/time and put it into a “No Useful Data” report and the data capture window would reflect no change.

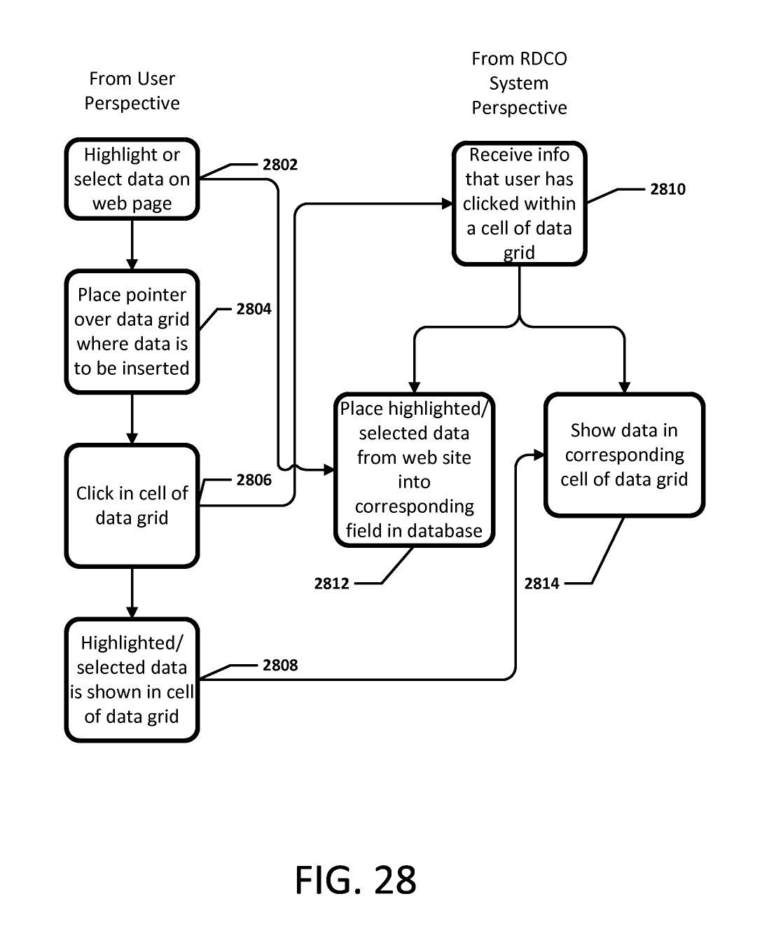

FIG. 28 shows how a browser deployment of the RDCO system functions like a “faux” spreadsheet, that is, it presents the user with what appears to be a spreadsheet, with labeled columns and data rows, but in fact is a form of “graphical input” device into a database. On the left is how this process works from the user's perspective. On the right is how this process works from the perspective of the RDCO system.

The data grid displayed when the user clicks link 1912 in the originating web site browser window may be missing data if the originating web site is unmapped, as shown in FIG. 21. As shown in FIG. 22A, the user may select data from the originating web site and click it into the data grid using her mouse or other pointer. Following the example shown, the price would thus be displayed in the “price” cell of the data grid. The user selects the desired data in the originating web site (FIG. 28, step 2802) and places the pointer over the appropriate cell of the data grid where she wants the data inserted (step 2804). For example, the user may select the price of a house shown in the originating web site and then place the pointer over the cell labeled “price” in the data grid. The user then clicks on the appropriate cell in the data grid (step 2806) and as a result, the data is stored in the RDCO database and shown in the cell (step 2808). This cell may be formatted to display the data in a particular format. For example, in FIG. 22, the data is displayed in a currency format, similar to a standard spreadsheet's “currency” format.

In this way, the data grid can perform like a “faux” spreadsheet for the user. However from the perspective of the RDCO system, the process is more complex.

The RDCO system recognizes when the user has clicked on a cell of the data grid. The RDCO is aware of which cell is clicked because the different cells are labeled uniquely and correspond to data fields within the RDCO database. The location/label is communicated using scripting language within the client, or web browser. Once the user clicks on a cell, the RDCO receives the cell location information (step 2810). The data grid cell information also corresponds to a particular field in the RDCO database. The RDCO system places the data that was selected in the originating web site into the corresponding field of the database (step 2812) and also displays the data in the corresponding cell of the data grid (step 2814). In the example given above, the price of the house would be placed in the “Price” field, or row/record, of the RDCO database corresponding to the appropriate house. The price may also be displayed in the data grid in the appropriate row corresponding to the appropriate house.

The manner in which a graphical user interface (GUI) senses the location of an indicator such as a cursor and passes the location's coordinates to an application that calls it is well-known. Similarly, just about every modern computer's operating system is able to sense such selection actions as a mouse click, tap of a finger on a screen or track pad. The RDCO system, calling on these existing functions, in effect implements a “mapping” of the location of a pointer (such as a cursor, fingertip, stylus position, etc.) to a field (column) of a record (row) in the database 1960, and then commits (causes to be stored) the data the user has selected (by a previous mouse click, by dragging, etc.) to the corresponding field upon some event such as another mouse click, by dropping the data, etc.

Other functions of the “faux” spreadsheet or data grid can be performed similarly. Client-side scripting language can be used to identify areas of the data grid that allow for insertion of data, deletion of data, sorting of data, inserting rows, inserting columns, inserting fields, inserting cells, formatting cells, etc.

FIGS. 19-26 show a web-based embodiment of the RDCO system. This means that the application container is a web-based program. However, the RDCO system need not be web browser-based and may instead be an application running on the operating system of a computing device. In this case, the RDCO system would run as an application container. The container would allow sizing of the windows of other applications so that they are all easily viewable on the computer monitor screen. The clickable link depicted by link 1912 in the figures may be associated with an operating system application rather than an application web site or an application within the browser. In this case, clicking the link would launch the RDCO system similarly to that previously described. If installed as an operating system-level application, the RDCO configuration can be memorized to reserve an exclusive area of the screen. The dedicated container may be fixed, expandable or minimize-able.

In conclusion, this embodiment of the RDCO system may be a web site or web or operating system application that is used for accessing, searching or collecting data items, both automatically and manually from multiple sources while providing an application container in a dedicated area of the screen to enable “at a glance” real-time results of data capture as it is occurring. The dedicated container may optionally be associated with a particular template chosen as being suited for the current search criteria. Common templates may be pre-configured and made available, or could be customized or created from scratch.

The illustrated configuration is therefore a “remote-remote” configuration inasmuch as the RDCO system is being accessed and operated primarily, and the data source is accessed and retrieved (for example as HTML code and linked files), over a network such as the Internet, even though the user interacts with both on her local computer. Such a configuration will be particularly advantageous in situations where the user is doing research using a low-capacity device such as a smart phone, although it is of course not limited to such situations. All four “RDCO/source permutations” are possible, however: remote/remote, local/local, local/remote and remote/local.

Consider a “local/local” or “local/remote” configuration. In such a case, the data capture and/or storage components of the RDCO system could be installed on the user's computer as an application or as an agent for later communication with and uploading (or possibly local storage) of collected data. This local application/agent could be launched in any conventional manner, whereupon template creation can be carried out as described above. The user could then open the data source, either as a locally stored file (local/local operation), or by accessing a web site (local/remote) as above, which can be presented as a frame within the RDCO system frame and searched as described above with reference to FIGS. 1-17. If the database is implemented locally, collected data can be stored as above, with no need (but with the option) for uploading to any “cloud” service or remote server; instead, the data can be sent to the local database, which may then even be implemented as a component of the RDCO system itself.

A “local/remote” or “local/local” configuration, or combination of these two, might be preferred by organizations that often carry out large-scale data collection and research projects, especially if they, for reasons of confidentiality and security, prefer not to store their research results outside the organization itself. In other words, if a group of users want to use the RDCO system often, or when not connected to the internet, they may prefer to install and run a copy of the RDCO system as a resident application. As one hypothetical example, a law firm might often have infringement projects and wish to research online materials such as the infringer's online information (to look for evidence of infringement), as well as case law presented by services such as Westlaw and patent texts such as on the USPTO web site. Of course, even in situations where some data is sourced via the internet, other data research could be based on locally stored files such as drafts of briefs or memos. The database that stores the accumulated research results could then be implemented on the firm's own server, or stored and later uploaded, for example, as a batch, to a secure server, including a virtual “cloud” server that includes a database.

In a “remote/local” configuration, the RDCO system and associated database are accessed and run via the network, but at least some data source is on the user's local computer. Such a configuration might be advantageous for users who expect to do few projects, and so do not wish to have to install any software locally, but who have a large number of locally stored documents that they would like to examine and compile information from. Coupled with conventional mechanisms for optical character recognition, such a configuration would allow the users to selectively and efficiently extract useful information from the documents and store/archive it in electronic, searchable form.

Of course, many implementations of the invention may well be a “hybrid” of these different configurations, with some local data sources to be researched and other sources accessible as web sites, and possibly with local, temporary buffering of collected data (making it easier to change before committing it to inclusion in the database) before sending it to the database in the remote server.

1. A method for collecting and organizing data comprising:
displaying on a display for a user a current primary window
displaying to the user a data capture window in the form of a data grid having a plurality of cells;
sensing, by a data-collection software module running within a user device, the presence of at least one data item within the primary window;
associating data items represented in the cells of the data capture window with corresponding records in a database;
in which:
the primary window and the data capture window are displayed simultaneously to the user so as to be non-overlapping.

2. The method of claim 1, further comprising associating the at least one data item with a corresponding one of the cells of the data capture window such that a representation of the data item is visible to the user in the corresponding cell.

3. The method of claim 2, further comprising:
sensing selection by the user, via a graphical user interface, of the at least one data item; and
associating the user-selected, at least one data item with the corresponding one of the cells of the data capture window upon sensing a corresponding indication by the user.

4. The method of claim 1, further comprising sensing the occurrence of a trigger event and, upon sensing the occurrence of the trigger event, sending the data items associated with cells of the data grid of the data capture window to the database for storage.

5. The method of claim 1, in which the primary window and the data capture window are displayed according to a configuration of a tiling window manager.

6. The method of claim 1, further comprising associating at least one auto-captured data item with a corresponding one of the cells of the data capture window automatically.

7. The method of claim 6, in which at least one auto-captured data item is also a data item visible to the user in the primary window.

8. The method of claim 6, in which at least one auto-captured data item is other than a data item visible to the user in the primary window.

9. The method of claim 1, in which at least one of the data items is an image.

10. A system for collecting and organizing data comprising:
a display on which a current primary window is displayed for a user as well as a data capture window in the form of a data grid having a plurality of cells;
a data-collection software module running within a user device as computer-executable code executing on a system hardware platform and configured for sensing the presence of at least one data item within the primary window and for associating data items represented in the cells of the data capture window with corresponding records in a database;
in which:
the primary window and the data capture data-collection software module window are displayed simultaneously to the user so as to be non-overlapping.

11. The system of claim 10, in which the data-collection software is further configured for associating the at least one data item with a corresponding one of the cells of the data capture window such that a representation of the data item is visible to the user in the corresponding cell.

12. The system of claim 11, further comprising:
a graphical user interface within the system hardware platform sensing selection by the user, of the at least one data item;
said data-collection software being further configured for associating the user-selected, at least one data item with the corresponding one of the cells of the data capture window upon sensing a corresponding indication by the user.

13. The system of claim 10, said data-collection software being further configured for sensing the occurrence of a trigger event and, upon sensing the occurrence of the trigger event, sending the data items associated with cells of the data grid of the data capture window to the database for storage.

14. The system of claim 10, further comprising a tiling window manager directing the display to display to the primary window and the data capture window.

15. The system of claim 10, in which the data-collection software is further configured for automatically associating at least one auto-captured data item with a corresponding one of the cells of the data capture window.

16. The system of claim 15, in which at least one auto-captured data item is also a data item visible to the user in the primary window.

17. The system of claim 15, in which at least one auto-captured data item is other than a data item visible to the user in the primary window.

18. The system of claim 10, in which at least one of the data items is an image.
